(19) United States
(12) Patent Application Publication
(10) Pub. No.: US 2019/0320358 A1
(43) Pub. Date: Oct. 17, 2019

(54) USER EQUIPMENT POWER OPTIMIZATION IN MILLIMETER WAVE ACCESS NETWORKS

(71) Applicant: QUALCOMM Incorporated, San Diego, CA (US)

(72) Inventor: Edward Knapp, Basking Ridge, NJ (US)

(21) Appl. No.: 15/955,420

(22) Filed: Apr. 17, 2018

(51) Int. Cl. H04W 36/00; H04W 64/00; H04W 24/08; H04W 52/02

(52) U.S. Cl. CPC H04W 36/0083; H04W 64/003; H04W 92/18; H04W 52/0209; H04W 24/08

(57) ABSTRACT

Methods, systems, and devices for wireless communication are described. A method at a user equipment (UE) may include listening for a device-to-device communication of a first wireless network using a first radio access technology (RAT), the UE in an idle state for a second RAT. The UE may receive the periodic device-to-device communication using the first RAT, the device-to-device communication including location information and quality for a base station of a second wireless network. The UE may then activate radio components of the UE into an active state based at least in part on the location information for the base station of the second wireless network, the radio components configured to support communications using the second RAT, and initiate the first mmW cell search attach procedure using the activated radio components.

### BACKGROUND

The following relates generally to wireless communication, and more specifically to power optimization in millimeter wave (mmW) access networks.

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include code division multiple access (CDMA) systems, time division multiple access (TDMA) systems, frequency division multiple access (FDMA) systems, and orthogonal frequency division multiple access (OFDMA) systems, (e.g., a Long Term Evolution (LTE) system, or a New Radio (NR) system). A wireless multiple-access communications system may include a number of base stations or access network nodes, each simultaneously supporting communication for multiple communication devices, which may be otherwise known as user equipment (UE).

Some wireless communication devices may be capable of operating in a network using mmW spectrum in addition to being capable of operating in wireless communications systems in other bands. The mmW spectrum of frequencies may serve as the basis for enhanced mobile broadband (eMBB) services. When using mmW networks, a base station may utilize directional beams (e.g., highly directional beams) to increase the data rates to a wireless device and reduce path loss. Directional beams may be very specific in the area they cover, may be blocked or attenuated significantly when passing through objects, and may be formed to target smaller areas than other wireless communications systems, for example wireless communications systems using lower, sub-mmW frequencies (e.g., less than 6 GHz). Transmissions using higher frequencies, such as mmW (e.g., greater than 6 GHz) may be characterized by smaller antennas and shorter ranges (e.g., less than 1 km) compared to transmission using the lower frequencies (and longer wavelengths) of the spectrum. Fully digital beamforming may allow such systems to transmit in multiple directions simultaneously, but the NR mmW networks typically “see” in only one beam direction at time.

In most cases, the base stations supporting wireless communications networks using mmW frequencies may be deployed in limited coverage areas relative to base stations supporting wireless communications using other sub-6 GHz frequencies. Thus, the coverage area of mmW networks may be limited (e.g., hot spot, highly non-uniform or non-contiguous in coverage) compared to other wireless networks, such as legacy cellular networks. A wireless device capable of communicating on a mmW network may consume power to search for mmW base stations by frequently waking up from an idle (e.g., power off, low power, sleep, or inactive), or other low power states to scan for mmW signals indicating the presence of a mmW network. Where mmW base stations are sparse, wireless network devices may frequently wake up to scan for reference signals for attaching to a mmW network. Also, when enabled or directed by other overlay networks, wireless devices may be directed to seek mmW networks that may not yet be available to attach. In many cases, these situations result in an inefficient use of resources, for example for many wireless battery operated devices the loss of energy as a result of excessive power consumption used in attempts to acquire such mmW networks.

### SUMMARY

The described techniques relate to improved methods, systems, devices, or apparatuses that support power optimization in millimeter wave (mmW) access networks. Generally, the described techniques provide for power saving procedures at a user equipment (UE) capable of communicating on a mmW network, specifically when the deployment of mmW base stations is sparse (e.g., hot spots) or non-contiguous in coverage. Such techniques may reduce the time a UE unsuccessfully searches for mmW networks, conserving UE resources, including power. A UE may receive an indication (e.g., location information) of the presence of a mmW network from its currently attached network or from another device in a first radio access network (RAT) before determining to search for the mmW network (a second RAT). In some cases, the indication may be received directly via device-to-device communications or indirectly via out of coverage mesh (e.g., multi hop) communications. A UE that is operating in the mmW network or has previously been operating in the mmW network may periodically transmit a device-to-device communication in a first RAT (e.g., a RAT used by a non-mmW network) that includes location information for the acquisition of one or more base stations in the mmW network using a second RAT. A base station of the mmW network, may be equipped with radio technology of the second RAT or may be collocated with equipment to also serve UEs using the first RAT. Further, the mmW base station may also be equipped with a collocated UE capable of device-to-device communications using the first or second RAT. For example, through the use of an embedded UE at the base station the presence and location of the mmW base station may be indicated.

A method of wireless communication is described. The method may include listening for a device-to-device communication of a first wireless network using a first RAT, the UE in an idle state for a second RAT, receiving the device-to-device communication using the first RAT, the device-to-device communication may include location information for a base station of a second wireless network, activating radio components of the UE into an active state based at least in part on the location information for the base station of the second wireless network, the radio components configured to support communications using the second RAT, and initiating a cell search procedure for the second RAT using the activated radio components.

An apparatus for wireless communication is described. The apparatus may include means for listening for a device-to-device communication of a first wireless network using a first RAT, the UE in an idle state for a second RAT, means for receiving the device-to-device communication using the first RAT, the device-to-device communication may include location information for a base station of a second wireless network, means for activating radio components of the UE into an active state based at least in part on the location information for the base station of the second wireless network, the radio components configured to support communications using the second RAT, and means for initiating a cell search procedure for the second RAT using the activated radio components.

Another apparatus for wireless communication is described. The apparatus may include a processor, memory in electronic communication with the processor, and instructions stored in the memory. The instructions may be operable to cause the processor to listen for a device-to-device communication of a first wireless network using a first RAT, the UE in an idle state for a second RAT, receive the device-to-device communication using the first RAT, the device-to-device communication may include location information for a base station of a second wireless network, activate radio components of the UE into an active state based at least in part on the location information for the base station of the second wireless network, the radio components configured to support communications using the second RAT, and initiate a cell search procedure for the second RAT using the activated radio components.

A non-transitory computer-readable medium for wireless communication is described. The non-transitory computer-readable medium may include instructions operable to cause a processor to listen for a device-to-device communication of a first wireless network using a first RAT, the UE in an idle state for a second RAT, receive the device-to-device communication using the first RAT, the device-to-device communication may include location information for a base station of a second wireless network, activate radio components of the UE into an active state based at least in part on the location information for the base station of the second wireless network, the radio components configured to support communications using the second RAT, and initiate a cell search procedure for the second RAT using the activated radio components.

In some examples of the method, apparatus, and non-transitory computer-readable medium described above, receiving the device-to-device communication may include: receiving the device-to-device communication from a second UE using the first RAT, the location information for the base station of the second wireless network based at least in part on signals received at the second UE in a connected state with the base station of the second wireless network.

In some examples of the method, apparatus, and non-transitory computer-readable medium described above, receiving the device-to-device communication may include: receiving the device-to-device communication from the base station of the second wireless network, the device-to-device communication formatted as a first RAT UE transmission.

Some examples of the method, apparatus, and non-transitory computer-readable medium described above may further include processes, features, means, or instructions for initiating a cell search procedure based at least in part on a determined distance between the UE and the base station being less than a threshold, or based at least in part on a signal strength being above a threshold, or based at least in part on a quality of coverage measurement at a location of the UE being above a threshold, or a combination thereof

Some examples of the method, apparatus, and non-transitory computer-readable medium described above may further include processes, features, means, or instructions for receiving one or more additional device-to-device communications from one or more additional UEs, each of the one or more additional device-to-device communications may include additional location information for the base station of the second wireless network. Some examples of the method, apparatus, and non-transitory computer-readable medium described above may further include processes, features, means, or instructions for estimating a location of the base station of the second wireless network, or of a coverage area of the base station, or a combination thereof, based at least in part on the one or more additional device-to-device communications.

In some examples of the method, apparatus, and non-transitory computer-readable medium described above, the location information may include coordinates for the UE and an indication of a measurement of a signal received at the UE from the base station.

Some examples of the method, apparatus, and non-transitory computer-readable medium described above may further include processes, features, means, or instructions for receiving, from a plurality of additional UEs, location information for base stations of the second wireless network. Some examples of the method, apparatus, and non-transitory computer-readable medium described above may further include processes, features, means, or instructions for generating a database of base station locations for the second wireless network and UE locations attached to the second wireless network based at least in part on the received location information.

In some examples of the method, apparatus, and non-transitory computer-readable medium described above, listening for the device-to-device communication may include: periodically listening for the device-to-device communication during a predetermined time interval for discovery of UEs transmitting device-to-device communications.

In some examples of the method, apparatus, and non-transitory computer-readable medium described above, the location information for the second wireless network may include coordinates for the base station of the second wireless network, or for a coverage area for the base station, or a combination thereof.

In some examples of the method, apparatus, and non-transitory computer-readable medium described above, the device-to-device communication may further include an identifier of the base station of the second wireless network, or a beam identifier for a transmit beam of the base station, or a measurement of a reference signal transmitted by the base station, or a combination thereof

In some examples of the method, apparatus, and non-transitory computer-readable medium described above, the first RAT operates using a radio frequency (RF) spectrum band less than 6 GHz. In some examples of the method, apparatus, and non-transitory computer-readable medium described above, the second RAT operates using a RF spectrum band greater than 6 GHz.

In some examples of the method, apparatus, and non-transitory computer-readable medium described above, listening for the device-to-device communication using the first RAT may further include: listening for the device-to-device communication in an idle state for the first RAT.

In some examples of the method, apparatus, and non-transitory computer-readable medium described above, listening for the device-to-device communication using the first RAT may further include: listening for the device-to-device communication in an active state for the first RAT.

In some examples of the method, apparatus, and non-transitory computer-readable medium described above, the first wireless network and the second wireless network geographically overlap.

A method of wireless communication is described. The method may include identifying, by a first wireless device configured to communicate in a first wireless network using a first RAT, location information for a base station of a second wireless network using a second RAT and transmitting, using the first RAT, a device-to-device communication from the first wireless device to a UE, the device-to-device communication may include the location information for the base station of the second wireless network.

An apparatus for wireless communication is described. The apparatus may include means for identifying, by a first wireless device configured to communicate in a first wireless network using a first RAT, location information for a base station of a second wireless network using a second RAT and means for transmitting, using the first RAT, a device-to-device communication from the first wireless device to a UE, the device-to-device communication may include the location information for the base station of the second wireless network.

Another apparatus for wireless communication is described. The apparatus may include a processor, memory in electronic communication with the processor, and instructions stored in the memory. The instructions may be operable to cause the processor to identify, by a first wireless device configured to communicate in a first wireless network using a first RAT, location information for a base station of a second wireless network using a second RAT and transmit, using the first RAT, a device-to-device communication from the first wireless device to a UE, the device-to-device communication may include the location information for the base station of the second wireless network.

A non-transitory computer-readable medium for wireless communication is described. The non-transitory computer-readable medium may include instructions operable to cause a processor to identify, by a first wireless device configured to communicate in a first wireless network using a first RAT, location information for a base station of a second wireless network using a second RAT and transmit, using the first RAT, a device-to-device communication from the first wireless device to a UE, the device-to-device communication may include the location information for the base station of the second wireless network.

In some examples of the method, apparatus, and non-transitory computer-readable medium described above, identifying the location information for the second wireless network may include: receiving, at the first wireless device, one or more signals from the base station of the second wireless network using the second RAT. Some examples of the method, apparatus, and non-transitory computer-readable medium described above may further include processes, features, means, or instructions for determining the location information for the base station based at least in part on the one or more signals.

In some examples of the method, apparatus, and non-transitory computer-readable medium described above, the one or more signals from the base station may include a system information signal of the base station, or a reference signal transmitted by the base station, or a combination thereof.

In some examples of the method, apparatus, and non-transitory computer-readable medium described above, the base station of the second wireless network may include the first wireless device, and the base station may be enabled or configured to transmit the device-to-device communication as a UE transmission.

In some examples of the method, apparatus, and non-transitory computer-readable medium described above, the first wireless device may include a UE embedded in the base station to transmit the device-to-device communication configured as the UE transmission.

Some examples of the method, apparatus, and non-transitory computer-readable medium described above may further include processes, features, means, or instructions for measuring a signal transmitted by the base station of the second wireless network, where the location information may include coordinates for the first wireless device and an indication of the measured signal.

In some examples of the method, apparatus, and non-transitory computer-readable medium described above, the location information may include coordinates for the base station of the second wireless network, or for a coverage area of the base station, or a combination thereof.

### BRIEF DESCRIPTION OF THE DRAWINGS

FIG. 1 illustrates an example of a system for wireless communication that supports user equipment (UE) power optimization in millimeter wave (mmW) access networks operation in accordance with aspects of the present disclosure.

FIGS. 2 through 4 illustrate examples of a wireless communications system that supports UE power optimization in mmW access networks in accordance with aspects of the present disclosure.

FIGS. 5 and 6 illustrate examples of a flow chart that support UE power optimization in mmW access networks in accordance with aspects of the present disclosure.

FIGS. 7 and 8 show block diagrams of a device that supports UE power optimization in mmW access networks in accordance with aspects of the present disclosure.

FIG. 9 illustrates a block diagram of a system including a UE that supports UE power optimization in mmW access networks in accordance with aspects of the present disclosure.

FIGS. 10 and 11 show block diagrams of a device that supports UE power optimization in mmW access networks in accordance with aspects of the present disclosure.

FIG. 12 illustrates a block diagram of a system including a wireless device that supports UE power optimization in mmW access networks in accordance with aspects of the present disclosure.

FIGS. 13 through 18 illustrate methods for UE power optimization in mmW access networks in accordance with aspects of the present disclosure.

### DETAILED DESCRIPTION

Searching for sparse or non-collocated multi-RAT wireless communication heterogeneous networks may cause excess power consumption at a user equipment (UE). As a result, users operating a UE that may be able to operate in different wireless communication networks may disable the use of the sparse wireless communication networks if the benefits of enhanced mobile broadband (eMBB) are not broadly and efficiently enabled. Such mobile UEs may thus not be capable of or desire to acquire the signals to allow communicating on the sparse network, which network may be capable of higher data transfer speeds, or otherwise be a more desirable network, than more widespread (e.g., sub-6 GHz or legacy) networks. Techniques that more deterministically minimize power consumption at a UE with the ability to connect to a mmW wireless communication network will limit or reduce unnecessary scanning or turn up of the radio transceiver power needed to access a sparse coverage communication network. Such techniques may enable more power efficient operation of the UE and user satisfaction. The UE may employ various forms of UE assisted data. In some examples, the UE assisted data may be used to optimize battery consumption of certain components of the UE, such as of a millimeter wave (mmW) radio frequency front-end control interface (RFFE) including the antenna elements, analog front-end (ANF) and digital front end (DFE) and baseband circuits as well as other non-modem RAT components such as processors that wake-up to prepare or service the device applications. In some examples, a UE may leverage out of band or sideband information received from devices or nodes of the second assisting network (e.g., first RAT) to determine when to optimally power on receive components of the UE for initial acquisition and synchronization with the sparse network. In some cases, both the sparse (e.g., mmW) network and the assisting (e.g., sub-6 GHz) network may be operated by the same network operator, though the networks may use different RATs.

In some cases, a mmW access network may not have contiguous coverage, and such coverage may be limited in geographic coverage or different relative to other, legacy wireless networks. Thus, a UE may wait to turn on the receive chain for mmW that allows the UE to search for the mmW network until a decision based on low frequency more uniform received information (e.g., out-of-band or sideband information) about the mmW coverage area is made. The information may provide radio wake up assistance for the UE. As sparse wireless networks (e.g., mmW networks) are initially deployed and are built out, and the number of base stations and coverage area increase, the techniques described herein may be beneficial for mmW UE power consumption optimization.

Aspects of the disclosure are initially described in the context of a wireless communications system. Example networks and process flows supporting techniques for UE power optimization in mmW access networks are then described. Aspects of the disclosure are further illustrated by and described with reference to apparatus diagrams, system diagrams, and flowcharts that relate to UE power optimization in mmW access networks.

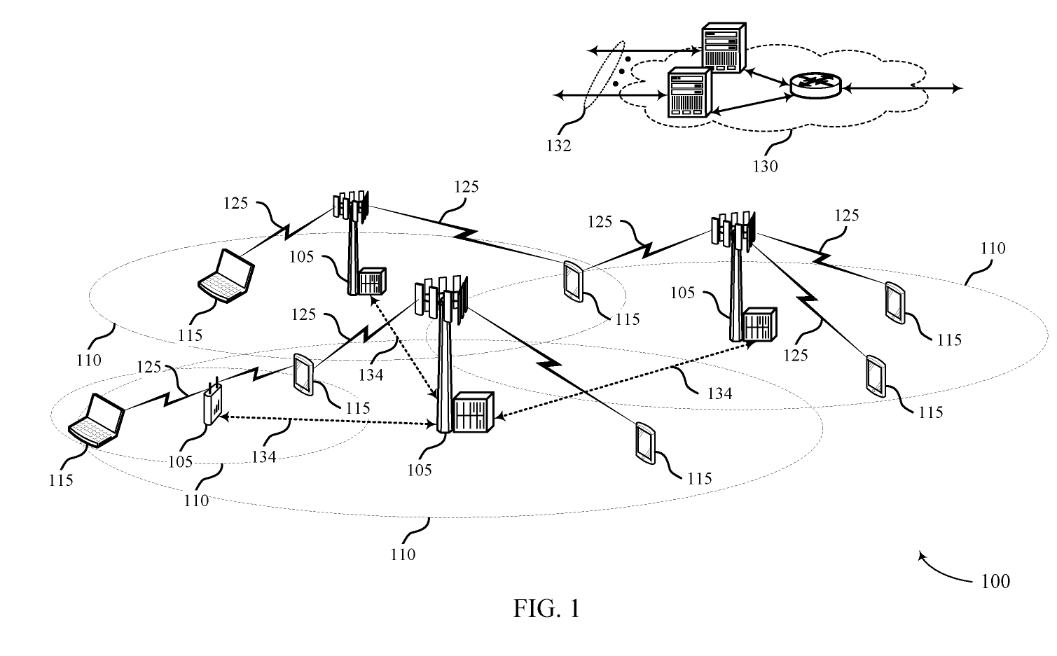

FIG. 1 illustrates an example of a wireless communications system 100 in accordance with various aspects of the present disclosure. The wireless communications system 100 includes base stations 105, UEs 115, and a core network 130. In some examples, the wireless communications system 100 may be a Long Term Evolution (LTE) network, an LTE-Advanced (LTE-A) network, an LTE-A Pro network, or a New Radio (NR) network. In some cases, wireless communications system 100 may support enhanced broadband communications, ultra-reliable (e.g., mission critical) communications, low latency communications, or communications with low-cost and low-complexity devices.

Base stations 105 may wirelessly communicate with UEs 115 via one or more base station antennas. Base stations 105 described herein may include or may be referred to by those skilled in the art as a base transceiver station, a radio base station, an access point, a radio transceiver, a NodeB, an eNodeB (eNB), a next-generation Node B or giga-nodeB (either of which may be referred to as a gNB), a Home NodeB, a Home eNodeB, or some other suitable terminology. Wireless communications system 100 may include base stations 105 of different types (e.g., macro or small cell base stations). The UEs 115 described herein may be able to communicate with various types of base stations 105 and network equipment including macro eNBs, small cell eNBs, gNBs, relay base stations, and the like.

Each base station 105 may be associated with a particular geographic coverage area 110 in which communications with various UEs 115 is supported. Each base station 105 may provide communication coverage for a respective geographic coverage area 110 via communication links 125, and communication links 125 between a base station 105 and a UE 115 may utilize one or more carriers. Communication links 125 shown in wireless communications system 100 may include uplink transmissions from a UE 115 to a base station 105, or downlink transmissions from a base station 105 to a UE 115. Downlink transmissions may also be called forward link transmissions while uplink transmissions may also be called reverse link transmissions.

The geographic coverage area 110 for a base station 105 may be divided into sectors or beams making up only a portion of the geographic coverage area 110, and each sector may be associated with a cell. For example, each base station 105 may provide communication coverage for a macro cell, a small cell, a hot spot, or other types of cells, or various combinations thereof. In some examples, a base station 105 may be movable and therefore provide communication coverage for a moving geographic coverage area 110. In some examples, different geographic coverage areas 110 associated with different technologies may overlap, and overlapping geographic coverage areas 110 associated with different technologies may be supported by the same base station 105 or by different base stations 105. The wireless communications system 100 may include, for example, a heterogeneous LTE/LTE-A/LTE-A Pro or NR network in which different types of base stations 105 provide coverage for various geographic coverage areas 110.

The term “cell” refers to a logical communication entity used for communication with a base station 105 (e.g., over a carrier), and may be associated with an identifier for distinguishing neighboring cells (e.g., a physical cell identifier (PCID), a virtual cell identifier (VCID)) operating via the same or a different carrier. In some examples, a carrier may support multiple cells, and different cells may be configured according to different protocol types (e.g., machine-type communication (MTC), narrowband Internet-of-Things (NB-IoT), enhanced mobile broadband (eMBB), or others) that may provide access for different types of devices. In some cases, the term “cell” may refer to a portion of a geographic coverage area 110 (e.g., a sector) over which the logical entity operates.

UEs 115 may be dispersed throughout the wireless communications system 100, and each UE 115 may be stationary or mobile. A UE 115 may also be referred to as a mobile device, a wireless device, a remote device, a handheld device, or a subscriber device, or some other suitable terminology, where the “device” may also be referred to as a unit, a station, a terminal, or a client. A UE 115 may also be a personal electronic device such as a cellular phone, a personal digital assistant (PDA), a tablet computer, a laptop computer, or a personal computer. In some examples, a UE 115 may also refer to a wireless local loop (WLL) station, an Internet of Things (IoT) device, an Internet of Everything (IoE) device, or an MTC device, or the like, which may be implemented in various articles such as appliances, vehicles, meters, or the like.

Some UEs 115, such as MTC or IoT devices, may be low cost or low complexity devices, and may provide for automated communication between machines (e.g., via Machine-to-Machine (M2M) communication). M2M communication or MTC may refer to data communication technologies that allow devices to communicate with one another or a base station 105 without human intervention. In some examples, M2M communication or MTC may include communications from devices that integrate sensors or meters to measure or capture information and relay that information to a central server or application program that can make use of the information or present the information to humans interacting with the program or application. Some UEs 115 may be designed to collect information or enable automated behavior of machines. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception simultaneously). In some examples half-duplex communications may be performed at a reduced peak rate. Other power conservation techniques for UEs 115 include entering a power saving “deep sleep” mode when not engaging in active communications, or operating over a limited bandwidth (e.g., according to narrowband communications). In some cases, UEs 115 may be designed to support critical functions (e.g., mission critical functions), and a wireless communications system 100 may be configured to provide ultra-reliable communications for these functions.

In some cases, a UE 115 may also be able to communicate directly with other UEs 115 (e.g., using a peer-to-peer (P2P) or device-to-device (D2D) protocol). One or more of a group of UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some cases, groups of UEs 115 communicating via D2D communications may utilize a one-to-many (1:M) system in which each UE 115 transmits to every other UE 115 in the group. In some cases, a base station 105 facilitates the scheduling of resources for D2D communications. In other cases, D2D communications are carried out between UEs 115 without the involvement of a base station 105.

Direct communication between UEs 115 may also include LTE-Direct (LTE-D) communications. LTE-D may be always on at UEs 115 and act as a discovery service based on proximity of other UEs 115 without the input of a user. LTE-D may be used in paired (e.g., TDD) and unpaired (e.g., FDD) spectrums. In some examples, LTE-D communications may include the use of expression beacons, which may provide low power consumption communications of 128 bits transmitted across a distance of about 500 meters. The active duration of an LTE-D communication may be about 64 to 75 milliseconds (ms). UEs 115 using LTE-D may base communication timing and resource allocation on the LTE network. UEs 115 may be capable of communicating via LTE-D with other UEs 115 of the same operator or across operators where all UEs 115 in a region may communicate via LTE-D using standard allocation of resources. According to various aspects of the disclosure, an LTE-D communication may indicate to a UE 115 that a mmW network is nearby, and the UE may determine to wait or based on its direction and service state to independently search for the mmW network by powering on its radio receive components to begin acquisition. In some examples, LTE-D expression communications (e.g., transmissions or receptions) may autonomously take place at UE 115 without user input initiating such transmissions or receptions.

Base stations 105 may communicate with the core network 130 and with one another. For example, base stations 105 may interface with the core network 130 through backhaul links 132 (e.g., via an S1 or other interface). Base stations 105 may communicate with one another over backhaul links 134 (e.g., via an X2 or other interface) either directly (e.g., directly between base stations 105) or indirectly (e.g., via core network 130).

The core network 130 may provide user authentication, access authorization, tracking, Internet Protocol (IP) connectivity, and other access, routing, or mobility functions. The core network 130 may be an evolved packet core (EPC), which may include at least one mobility management entity (MME), at least one serving gateway (S-GW), and at least one Packet Data Network (PDN) gateway (P-GW). The MME may manage non-access stratum (e.g., control plane) functions such as mobility, authentication, and bearer management for UEs 115 served by base stations 105 associated with the EPC. User IP packets may be transferred through the S-GW, which itself may be connected to the P-GW. The P-GW may provide IP address allocation as well as other functions. The P-GW may be connected to the network operators IP services. The operators IP services may include access to the Internet, Intranet(s), an IP Multimedia Subsystem (IMS), or a Packet-Switched (PS) Streaming Service.

At least some of the network devices, such as a base station 105, may include subcomponents such as an access network entity, which may be an example of an access node controller (ANC). Each access network entity may communicate with UEs 115 through a number of other access network transmission entities, which may be referred to as a remote radio head, a smart radio head, or a transmission/reception point (TRP). In some configurations, various functions of each access network entity or base station 105 may be distributed across various network devices (e.g., radio heads and access network controllers) or consolidated into a single network device (e.g., a base station 105).

In wireless communications system 100 (e.g., a 5G NR system), the functions of the core network 130 may be virtualized to allow for a more flexible architecture. Specifically, a core network 130 may include several entities (e.g., functions) such as access and mobility management functions (AMFs), session management functions (SMFs), authentication server functions (AUSFs), unified data management (UDM), user plane functions (UPFs), policy control functions (PCFs), and authorization functions (AFs), and others, that may be virtually implemented in software. A wireless communications system 100 may support techniques for efficient communication between a UE 115 and different entities (or functions) of a core network 130. Specifically, in some examples, the UE 115 may interact with a single entity of a core network 130 (e.g., an AMF), and any data transmitted between the UE 115 and other network entities may pass through the AMF.

Wireless communications system 100 may operate using one or more frequency bands, typically in the range of 300 MHz to 300 GHz. Generally, the region from 300 MHz to 3 GHz is known as the ultra-high frequency (UHF) region or decimeter band, since the wavelengths range from approximately one decimeter to one meter in length. UHF waves may be blocked or redirected by buildings and environmental features. However, the waves may penetrate structures sufficiently for a macro cell to provide service to UEs 115 located indoors. Transmission of UHF waves may be associated with smaller antennas and shorter range (e.g., less than 100 km) compared to radio transmission using the lower frequencies and longer wavelengths of the high frequency (HF) or very high frequency (VHF) portion of the spectrum below 300 MHz.

Wireless communications system 100 may also operate in a super high frequency (SHF) region using frequency bands from 3 GHz to 30 GHz, also known as the centimeter band. The SHF region includes bands such as the 5 GHz multiplex industrial, scientific, and medical (ISM) bands, which may be used opportunistically by devices that can tolerate interference from other users.

Wireless communications system 100 may also operate in an extremely high frequency (EHF) region of the spectrum (e.g., from approximately 30 GHz to 300 GHz), also known as the millimeter band, where communications utilizing such frequencies may be referred to as millimeter wave (mmW) communications. In some case, communications utilizing frequencies in the spectrum from approximately 24 GHz to 28 GHz may also be generally understood to be mmW communications. In some examples, wireless communications system 100 may support mmW communications between UEs 115 and base stations 105, and EHF antennas of the respective devices may be even smaller and more closely spaced than UHF antennas. In some cases, this may facilitate use of antenna arrays within a UE 115. However, the propagation of EHF transmissions may be subject to even greater atmospheric attenuation and shorter range than SHF or UHF transmissions. Techniques disclosed herein may be employed across transmissions that use one or more different frequency regions, and designated use of bands across these frequency regions may differ by country or regulating body.

In some cases, wireless communications system 100 may utilize both licensed and unlicensed radio frequency spectrum bands. For example, wireless communications system 100 may employ License Assisted Access (LAA), LTE-Unlicensed (LTE-U) radio access technology, or NR technology in an unlicensed band such as the 5 GHz ISM band. When operating in unlicensed radio frequency spectrum bands, wireless devices such as base stations 105 and UEs 115 may employ listen-before-talk (LBT) procedures to ensure a frequency channel is clear before transmitting data. In some cases, operations in unlicensed bands may be based on a CA configuration in conjunction with CCs operating in a licensed band (e.g., LAA). Operations in unlicensed spectrum may include downlink transmissions, uplink transmissions, peer-to-peer transmissions, or a combination of these. Duplexing in unlicensed spectrum may be based on frequency division duplexing (FDD), time division duplexing (TDD), or a combination of both.

In some examples, base station 105 or UE 115 may be equipped with multiple antennas, which may be used to employ techniques such as transmit diversity, receive diversity, multiple-input multiple-output (MIMO) communications, or beamforming. For example, wireless communications system 100 may use a transmission scheme between a transmitting device (e.g., a base station 105) and a receiving device (e.g., a UE 115), where the transmitting device is equipped with multiple antennas and the receiving devices are equipped with one or more antennas. MIMO communications may employ spatial multiplexing signal propagation to increase the communications spectral efficiency (e.g., capacity). The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream, and may carry bits associated with the same data stream (e.g., the same codeword) or different data streams. Different spatial layers may be associated with different antenna ports used for channel measurement and reporting. MIMO techniques include single-user MIMO (SU-MIMO) where multiple spatial layers are transmitted to the same receiving device, and multiple-user MIMO (MU-MIMO) where multiple spatial layers are transmitted to multiple devices.

Beamforming, which may also be referred to as spatial filtering, directional transmission, or directional reception, is a signal processing technique that may be used at a transmitting device or a receiving device (e.g., a base station 105 or a UE 115) to shape or steer an antenna beam (e.g., a transmit beam or receive beam) along a spatial path between the transmitting device and the receiving device. Beamforming may be achieved by combining the signals communicated via antenna elements of an antenna array such that signals propagating at particular orientations with respect to an antenna array experience constructive interference while others experience destructive interference. The adjustment of weighted signals communicated via the antenna elements may include a transmitting device or a receiving device applying certain amplitude and phase offsets to signals carried via each of the antenna elements associated with the device. The adjustments associated with each of the antenna elements may be defined by a beamforming weight set associated with a particular orientation (e.g., with respect to the antenna array of the transmitting device or receiving device, or with respect to some other orientation).

In one example, a base station 105 may use multiple antennas or antenna arrays to conduct beamforming operations for directional communications with a UE 115. For instance, some signals (e.g., synchronization signals, reference signals, beam selection signals, or other control signals) may be transmitted by a base station 105 periodically at multiple times in different directions, which may include a signal being transmitted according to different beamforming weight sets associated with different directions of transmission by using the transmitted symbols. Transmissions in different beam directions may be used to identify (e.g., by the base station 105 or a receiving device, such as a UE 115) a beam direction for subsequent transmission and/or reception by the base station 105. Some signals, such as data signals associated with a particular receiving device, may be transmitted by a base station 105 in a single beam direction (e.g., a direction associated with the receiving device, such as a UE 115). In some examples, the beam direction associated with transmissions along a single beam direction may be determined based at least in in part on a signal that was transmitted in different beam directions. For example, a UE 115 may receive one or more of the signals transmitted by the base station 105 in different directions, and the UE 115 may report to the base station 105 an indication of the signal it received with a highest signal quality, or an otherwise acceptable signal quality. Although these techniques are described with reference to signals transmitted in one or more directions by a base station 105, a UE 115 may employ similar techniques for transmitting signals multiple times in different directions (e.g., for identifying a beam direction for subsequent transmission or reception by the UE 115), or transmitting a signal in a single direction (e.g., for transmitting data to a receiving device).

A receiving device (e.g., a UE 115, which may be an example of a mmW receiving device) may try multiple receive beams when receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets applied to signals received at a plurality of antenna elements of an antenna array, or by processing received signals according to different receive beamforming weight sets applied to signals received at a plurality of antenna elements of an antenna array, any of which may be referred to as “listening” according to different receive beams or receive directions. In some examples a receiving device may use a single receive beam to receive along a single beam direction (e.g., when receiving a data signal). The single receive beam may be aligned in a beam direction determined based at least in part on listening according to different receive beam directions (e.g., a beam direction determined to have a highest signal strength, highest signal-to-noise ratio, or otherwise acceptable signal quality based at least in part on listening according to multiple beam directions).

In some cases, the antennas of a base station 105 or UE 115 may be located within one or more antenna arrays, which may support MIMO operations, or transmit or receive beamforming. For example, one or more base station antennas or antenna arrays may be co-located at an antenna assembly, such as an antenna tower. In some cases, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations.

In some cases, wireless communications system 100 may be a packet-based network that operate according to a layered protocol stack. In the user plane, communications at the bearer or Packet Data Convergence Protocol (PDCP) layer may be IP-based. A Radio Link Control (RLC) layer may in some cases perform packet segmentation and reassembly to communicate over logical channels. A Medium Access Control (MAC) layer may perform priority handling and multiplexing of logical channels into transport channels. The MAC layer may also use hybrid automatic repeat request (HARD) to provide retransmission at the MAC layer to improve link efficiency. In the control plane, the Radio Resource Control (RRC) protocol layer may provide establishment, configuration, and maintenance of an RRC connection between a UE 115 and a base station 105 or core network 130 supporting radio bearers for user plane data. At the Physical (PHY) layer, transport channels may be mapped to physical channels.

A UE may be capable of switching off its receiver and/or transmitter to conserve power when no data is to be received and/or transmitted, while also being capable of quick access to the network (e.g., NR system). A NR RRC connected inactive state may be designed as a sleep state for the NR network. RRC connected inactive may include adaptable DRX cycles (e.g., configurable in the range from milliseconds to hours) allowing for different configurations in terms of power consumption and accessibility delays. The state may also include UE controlled mobility and RAN-based paging (e.g., configured state transitions when a UE is semi-static). Camping for idle UEs may be included in the RRC connected inactive state. The state may also include configurable multi-RAT procedures, which may include multi-RAT camping, as well as configurable procedures that may take into account known characteristics at the RAN level (e.g., mobility patterns, traffic characteristics, etc.) for the different requirements in terms of accessibility delay.

In some cases, UEs 115 and base stations 105 may support retransmissions of data to increase the likelihood that data is received successfully. HARQ feedback is one technique of increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., signal-to-noise conditions). In some cases, a wireless device may support same-slot HARQ feedback, where the device may provide HARQ feedback in a specific slot for data received in a previous symbol in the slot. In other cases, the device may provide HARQ feedback in a subsequent slot, or according to some other time interval.

Time intervals in LTE or NR may be expressed in multiples of a basic time unit, which may, for example, refer to a sampling period of Tₛ=1/30,720,000 seconds. Time intervals of a communications resource may be organized according to radio frames each having a duration of 10 ms, where the frame period may be expressed as T_{f}=307,200 Tₛ. The radio frames may be identified by a system frame number (SFN) ranging from 0 to 1023. Each frame may include 10 subframes numbered from 0 to 9, and each subframe may have a duration of 1 ms. A subframe may be further divided into 2 slots each having a duration of 0.5 ms, and each slot may contain 6 or 7 modulation symbol periods (e.g., depending on the length of the cyclic prefix prepended to each symbol period). Excluding the cyclic prefix, each symbol period may contain 2048 sampling periods or varying sampling periods in NR. In another example, an NR system may have a sampling rate that is a multiple of 30.72 samples per second for a 15 kHz subcarrier. A 30 kHz subcarrier may take 61.44 samples per second, a 60 kHz subcarrier may take 122.88 samples per second, and so on. In some cases, a subframe may be the smallest scheduling unit of the wireless communications system 100, and may be referred to as a transmission time interval (TTI). In other cases, a smallest scheduling unit of the wireless communications system 100 may be shorter than a subframe or may be dynamically selected (e.g., in bursts of shortened TTIs (sTTIs) or in selected component carriers using sTTIs). In some cases, different TTIs may use different numerologies, where a subcarrier spacing may be larger or smaller. For a particular numerology value a slot length may be shorter or longer, while the number of symbol periods may remain the same. For example a shorter slot length with a larger subcarrier spacing may be used for a first TTI, while a longer slot length with a smaller subcarrier spacing may be used for a second TTI.

In some wireless communications systems, a slot may further be divided into multiple mini-slots containing one or more symbols. In some instances, a symbol of a mini-slot or a mini-slot may be the smallest unit of scheduling. Each symbol may vary in duration depending on the subcarrier spacing or frequency band of operation, for example. Further, some wireless communications systems may implement slot aggregation in which multiple slots or mini-slots are aggregated together and used for communication between a UE 115 and a base station 105.

The term “carrier” refers to a set of radio frequency spectrum resources having a defined physical layer structure for supporting communications over a communication link 125. For example, a carrier of a communication link 125 may include a portion of a radio frequency spectrum band that is operated according to physical layer channels for a given radio access technology. Each physical layer channel may carry user data, control information, or other signaling. A carrier may be associated with a pre-defined frequency channel (e.g., an E-UTRA absolute radio frequency channel number (EARFCN)), and may be positioned according to a channel raster for discovery by UEs 115. Carriers may be downlink or uplink (e.g., in an FDD mode), or be configured to carry downlink and uplink communications (e.g., in a TDD mode). In some examples, signal waveforms transmitted over a carrier may be made up of multiple sub-carriers (e.g., using multi-carrier modulation (MCM) techniques such as OFDM or DFT-s-OFDM).

The organizational structure of the carriers may be different for different radio access technologies (e.g., LTE, LTE-A, LTE-A Pro, NR, etc.). For example, communications over a carrier may be organized according to TTIs or slots, each of which may include user data as well as control information or signaling to support decoding the user data. A carrier may also include dedicated acquisition signaling (e.g., synchronization signals or system information, etc.) and control signaling that coordinates operation for the carrier. In some examples (e.g., in a carrier aggregation configuration), a carrier may also have acquisition signaling or control signaling that coordinates operations for other carriers.

Physical channels may be multiplexed on a carrier according to various techniques. A physical control channel and a physical data channel may be multiplexed on a downlink carrier, for example, using time division multiplexing (TDM) techniques, frequency division multiplexing (FDM) techniques, or hybrid TDM-FDM techniques. In some examples, control information transmitted in a physical control channel may be distributed between different control regions in a cascaded manner (e.g., between a common control region or common search space and one or more UE-specific control regions or UE-specific search spaces).

A carrier may be associated with a particular bandwidth of the radio frequency spectrum, and in some examples the carrier bandwidth may be referred to as a “system bandwidth” of the carrier or the wireless communications system 100. For example, the carrier bandwidth may be one of a number of predetermined bandwidths for carriers of a particular radio access technology (e.g., 1.4, 3, 5, 10, 15, 20, 40, 80, or 100 MHz). In some cases, mmW spectrum carriers may be 400 MHz in bandwidth and multiple carriers can be used up to 800 MHz or even 1.2 GHz with 100 MHz CCs. In some examples, each served UE 115 may be configured for operating over portions or all of the carrier bandwidth. In other examples, some UEs 115 may be configured for operation using a narrowband protocol type that is associated with a predefined portion or range (e.g., set of subcarriers or RBs) within a carrier (e.g., “in-band” deployment of a narrowband protocol type).

In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme). Thus, the more resource elements that a UE 115 receives and the higher the order of the modulation scheme, the higher the data rate may be for the UE 115. In MIMO systems, a wireless communications resource may refer to a combination of a radio frequency spectrum resource, a time resource, and a spatial resource (e.g., spatial layers), and the use of multiple spatial layers may further increase the data rate for communications with a UE 115.

Devices of the wireless communications system 100 (e.g., base stations 105 or UEs 115) may have a hardware configuration that supports communications over a particular carrier bandwidth or may be configurable to support communications over one of a set of carrier bandwidths. In some examples, the wireless communications system 100 may include base stations 105 and/or UEs that can support simultaneous communications via carriers associated with more than one different carrier bandwidth.

Wireless communications system 100 may support communication with a UE 115 on multiple cells or carriers, a feature which may be referred to as carrier aggregation (CA) or multi-carrier operation. A UE 115 may be configured with multiple downlink component carriers (CCs) and one or more uplink CCs according to a carrier aggregation configuration. Carrier aggregation may be used with both FDD and TDD component carriers.

In some cases, wireless communications system 100 may utilize enhanced component carriers (eCCs). An eCC may be characterized by one or more features including wider carrier or frequency channel bandwidth, shorter symbol duration, shorter TTI duration, or modified control channel configuration. In some cases, an eCC may be associated with a carrier aggregation configuration or a dual connectivity configuration (e.g., when multiple serving cells 105 are connected to a single UE 115 and may have a suboptimal or non-ideal backhaul link). An eCC may also be configured for use in unlicensed spectrum or shared spectrum (e.g., where more than one operator is allowed to use the spectrum). An eCC characterized by wide carrier bandwidth may include one or more segments that may be utilized by UEs 115 that are not capable of monitoring the whole carrier bandwidth or are otherwise configured to use a limited carrier bandwidth (e.g., to conserve power).

In some cases, an eCC may utilize a different symbol duration than other CCs, which may include use of a reduced symbol duration as compared with symbol durations of the other CCs. A shorter symbol duration may be associated with increased spacing between adjacent subcarriers. A device, such as a UE 115 or base station 105, utilizing eCCs may transmit wideband signals (e.g., according to frequency channel or carrier bandwidths of 20, 40, 60, 80, 100 MHz etc.) at reduced symbol durations (e.g., 16.67 microseconds). A TTI in eCC may consist of one or multiple symbol periods. In some cases, the TTI duration (that is, the number of symbol periods in a TTI) may be variable.

Wireless communications systems such as an NR system may utilize any combination of licensed, shared, and unlicensed spectrum bands, among others. For example, an NR system may utilize device-to-device communications, which allow direct communication between UEs 115 independent of base station 105. The flexibility of eCC symbol duration and subcarrier spacing may allow for the use of eCC across multiple spectrums. In some examples, NR shared spectrum may increase spectrum utilization and spectral efficiency, specifically through dynamic vertical (e.g., across frequency) and horizontal (e.g., across time) sharing of resources.

UE 115 may be currently communicating with a wireless communication network using a first RAT. UE 115 may be configured to receive an indication that triggers the determination to power on receive components of the UE 115 so that the UE 115 can communicate with a nearby wireless communication network using a second RAT. The indication may be received from a variety of devices in a variety of ways. An indication may include the location information of the new wireless network (e.g., the location of the base station of the wireless network) and more information related to the network. In one example, the system information of the RAT UE 115 is currently in communication with may indicate the presence of another wireless network using a different RAT nearby. In another example, a non-3GPP always-on low power radio (e.g., Bluetooth or Wi-Fi) may be embedded in a base station 105 of the new network to indicate, to a UE 115, sideband information regarding the presence of the proximal network. In another example, device-to-device (e.g., LTE-D) communications may be used by one UE 115 to provide an indication to another UE 115 that a wireless network using a different RAT is nearby. The device-to-device or LTE-D communications may be between a first UE 115 and a second UE 115, or between a UE 115 and a device logically or physically embedded in a base station 105 that is configured to transmit device-to-device communications.

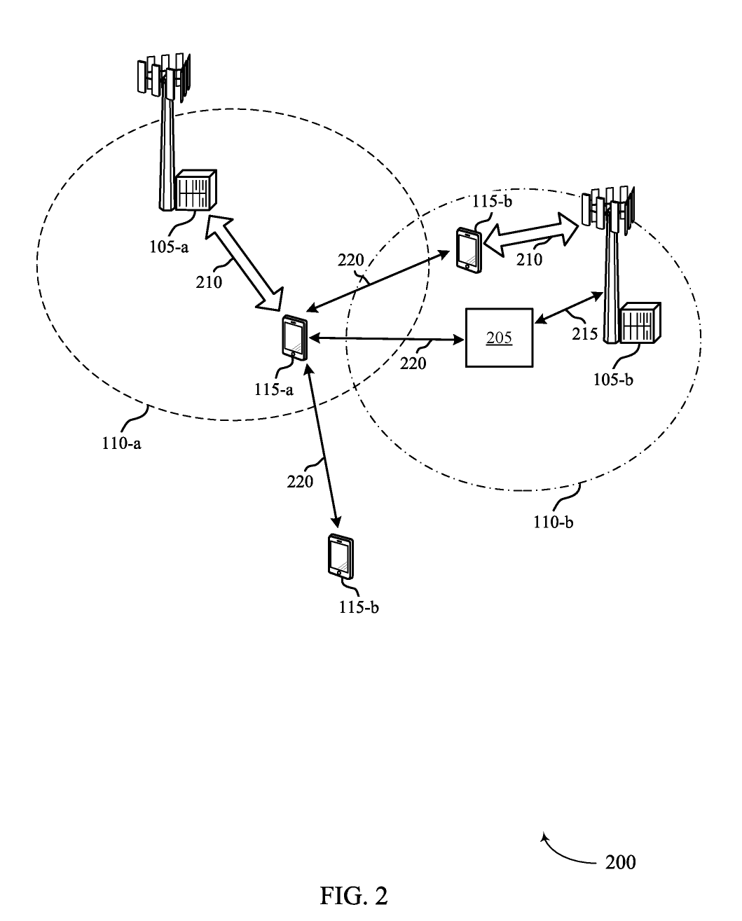

FIG. 2 illustrates an example of a wireless communications system 200 that supports UE power optimization in mmW access networks in accordance with various aspects of the present disclosure. Wireless communications system 200 includes base stations 105 and UEs 115 each of which may be an example of the corresponding devices as described with reference to FIG. 1. Wireless communications system 200 also includes wireless device 205.

Wireless communications system 200 may support multiple wireless networks. For example, base station 105-a may provide a wireless network with coverage area 110-a, and base station 105-b may provide a wireless network with coverage area 110b. Coverage areas 110-a and 110b are shown as partially overlapping, however, in some cases these coverage areas 110-a and 110b may be completely overlapping (e.g., a 4G coverage area 110-a may encompass a smaller single mode NR coverage area 110b). In the case where coverage areas 110-a and 110b may be completely overlapping, the coverage areas 110-a and 110b may share a common origin. In other cases, these coverage areas 110-a and 110b may not overlap at all. Base stations 105-a and 105-b may operate using different radio access technologies (RATs). For example, base station 105-a may operate using a first RAT (e.g., LTE or 4G) and base station 105-b may operate using a second RAT (e.g., 5G or NR). Base station 105-a may include link 210 for communication with UE 115-a and may also include additional links for communication with additional UEs (not shown) within coverage area 110-a. Similarly, base station 105-b may include link 210 for communication with UE 115-b and link 215 for communication with wireless device 205 and may also include additional links for communication with additional UEs (not shown) within coverage area 110b.

By way of example, UE 115-a may be communicating with base station 105-a using LTE, and radio components of UE 115-a that support NR communications may be powered off. UE 115-a may be configured to minimally power on its NR radio components unless or until an indication of a NR wireless network is detected directly via the periodic wake up of a 5G NR radio (e.g., via a broadcast messages from base station 105-a) or indirectly via sideband or other methods. Such techniques (or similar techniques) may conserve power by allowing a UE 115-a to search for NR wireless networks very intermittently (e.g., based on receiving an indication), rather than continuously searching to detect synchronization beam(s) and reference symbols. Examples of indication techniques for determining when to power on components to search for NR wireless networks are described herein. Accordingly, an alternative indication of the presence of a NR wireless network may result in NR radio components of UE 115-a (e.g., a receive chain configured to support NR) powering on in preparation to support NR communications. An indication of a NR network may also be used by a UE 115-b in communication with base station 105-b, which has its NR radio components powered on, to determine when to use a different wireless network and power down the NR radio components.

In some examples, UE 115-a may receive an indication of the presence of an NR wireless network and then make a determination to power on NR components or to keep the NR components off. In either case, a UE 115-a may be capable of receiving the indication of an NR network from serving base station 105-a, UEs 115-b, and wireless device 205 via a variety of methods described below.

UE 115-a may receive an indication of the presence of base station 105-b from serving base station 105-a. For example, base station 105-a may be aware of the presence of base station 105-b and may broadcast the presence of base station 105-b. Base station 105-a may broadcast the indication of base station 105-b using the physical broadcast channel (PBCH) such that active UEs 115 in coverage area 110-a may receive the broadcast system indication. System information may be used to transmit the indication periodically from base station 105-a. For example, the indication may be included in the system information block (SIB), the master information block (MIB), or both, of the wireless network of base station 105-a.

In the case when coverage area 110-a and coverage area 110b partially overlap or do not overlap at all, UE 115-a may receive the indication of the presence of base station 105-b and then decide if the radio components to communicate with base station 105-b should be powered on. For example, the UE 115-a may consider its own location and a forecasted trajectory in deciding to power on additional radio components. In some examples, if UE 115-a determines that it is moving closer to base station 105-b, or if UE 115-a is within a certain threshold distance from the coverage area 110b or base station 105-b, the UE may determine to power on the additional radio components of UE 115-a. However, if UE 115-a determines that it is moving away from base station 105-b, or if UE 115-a is outside of a certain threshold distance from the coverage area 110b or base station 105-b, UE 115-a may determine not to power on the additional radio components, or delay turning on the additional radio components for a certain duration of time.

Additionally or alternatively, UE 115-a may receive an indication of the presence of base station 105-b from wireless device 205. Wireless device 205 may be a low cost radio that is always on (e.g., Bluetooth or Wi-Fi) and capable of dual mode operation (e.g., operate in NR and Wi-Fi, or in NR and Bluetooth). Wireless device 205 may be embedded in base station 105-b or may be at a fixed location within coverage area 110b separate from base station 105-b and may or may not be power constrained. By way of example, when UE 115-a comes within a certain distance of wireless device 205, UE 115-a will receive an indication of the presence of base station 105-b via a low cost, low power, already active radio communication link 220 (e.g., a Bluetooth beacon or a Wi-Fi service set identifier (SSID) scan). Communication link 220 may provide sideband information related to the wireless network of base station 105-b to UE 115-a. If wireless device 205 is capable of transmitting beyond the coverage area 110b, a receiving UE (e.g., UE 115-a) may also make the determination based on the information received to power on the additional radio components. In another case, wireless device 205 may not be capable of transmitting beyond the coverage area 110b, and receiving UE (e.g., UE 115-a) may determine that they are within coverage area 110b and power on the additional radio components. By embedding wireless device 205 within the base station 105-b, a one-to-one correlation may exist for a wireless device 205 signal to the presence of wireless network of base station 105-b.

In another example, UE 115-a may receive an indication of the presence of base station 105-b via device-to-device (D2D) communications (e.g., LTE-D, which may be 4G or 5G-based LTE-D communications). UE 115-a may be capable of D2D communications with UEs 115-b and wireless device 205. In one example, wireless device 205 may be a UE similar to UE 115-b in communication with base station 105-b. In another example, wireless device 205 may be embedded in base station 105-b and be configured to act as a UE in D2D communications. D2D communications indicating the presence of base station 105-b may be transmitted periodically using a broadcast D2D method, such that UEs 115, or other wireless devices, within a certain distance from the transmitting device may receive the indication. In some cases, UE 115-a need not be actively connected to a wireless network in order to receive D2D communications. In other words, UE 115-a may not be in active communication (e.g., be operating in an idle or sleep state or mode) with base station 105-a but may still be able to wake up and periodically communicate via D2D communications with UEs 115-b and wireless device 205.

UE 115-a may receive an indication of the presence of a wireless network (e.g., base station 105-b) from UE 115-b within the coverage area 110b. UE 115-b may be in communication with base station 105-b. UE 115-b may transmit an indication that includes information related to the wireless network from base station 105-b that the UE 115-b is currently aware of. For example, the information may be based on measurements related to the current wireless connection (e.g., recently received signals) between the UE 115-b and base station 105-b. This information may include one or more of the location (relative or exact) of the UE 115-b, the location (relative or exact) of the base station 105-b, the signal strength of link 210 from base station 105-b, the beam ID of link 210, and the base station ID of base station 105-b. When wireless device 205 is a UE, it may operate similarly to UE 115-b within coverage area 110b.

In examples where wireless device 205 is a wireless device embedded in base station 105-b or at a fixed location within coverage area 110b separate from base station 105-b, wireless device 205 may operate similarly to UE 115-b within coverage area 110b. One difference between wireless device 205 and UE 115-b is that wireless device 205 is stationary because it is embedded in the base station 105-b, whereas UE 115-b may be mobile. A benefit of wireless device 205 being embedded in base station 105-b is that there may always be a D2D device broadcasting the presence of the wireless network to identify where a link such as link 210 may be established with high confidence. Wireless device 205 may also be controllable or managed by base station 105-b.

UE 115-a may receive an indication of a wireless network (e.g., base station 105-b) from UE 115-b outside of the coverage area 110b. UE 115-b may not be in communication with base station 105-b, but UE 115-b may have previously been in communication with base station 105-b. UE 115-b may transmit an indication that includes information of the wireless network from base station 105-b that the UE 115-b was previously aware of before leaving coverage area 110b. This information may include one or more of a previous location (relative or exact) of the UE 115-b within coverage area 110b, the location (relative or exact) of the base station 105-b, the signal strength of link 210 from base station 105-b, the beam ID of a link for the previous location of the UE 115-b, and the base station ID of base station 105-b. In some cases, UE 115-b may transmit the D2D indication for a specific time or distance after exiting coverage area 110b and stopping communication with base station 105-b. This information received from UE 115-b or other similar D2D mobile devices with information on the wireless network 110b may allow for a rich data set to enable lower power at UE 115-a when both waking up mmW transmit and receive components closer to the coverage area 110b or base station 105-b. This information may provide for faster and higher probability of acquisition of and synchronization with the PSS, SSS, broadcast reference signal (BRS) reference timing to receive or transmit NR data. In some cases, there may be control plane differences to consider such as with non-standalone NR networks and standalone NR networks.

UE 115-a may compile the multiple received indications in order to narrow the possible proximity of the base station 105-b. UE 115-a may leverage this additional information when determining to power on additional radio components. Also, once UE 115-a connects to base station 105-b, UE 115-a may still continue to use the received indications and information UE 115-a detects to form a map of the relative mmW coverage wireless network of base station 105-b. This map may be stored locally at the UE 115-a, where it may be transmitted to a database operating on the wireless network for UEs to access (e.g., network of base station 105-b or 105-a).

Additionally or alternatively, UE 115-a may receive an indication of the presence of base station 105-b from a pre-stored database. The pre-stored database may be built from crowdsourced information. For example, each UE that connects to base station 105-b may store one or more of the location (relative or exact) of the UE 115-b, the location (relative or exact) of the base station 105-b, the signal strength of link 210 from base station 105-b, the beam ID of link 210, and the base station ID of base station 105-b. In some locations, for example during handover, the UE 115-a may see or detect both base station 105-a and base station 105-b, or may see or detect base station 105-a, base station 105-b, and one or more additional base stations. The database may be stored on the wireless network of base station 105-a or the wireless network of base station 105-b. In some examples, the database may develop a map of the coverage area 110b from current connected devices or information from previously connected devices (e.g., UE 115-b).

The first RAT and the second RAT may be different in various ways that make the techniques described herein beneficial. For example, the second RAT may be characterized by base stations that have reduced range relative to base stations of the first RAT. In other examples, due to technological development and historical deployment there may be relatively fewer base stations that operate to support the second RAT than there are base stations that support the first RAT.

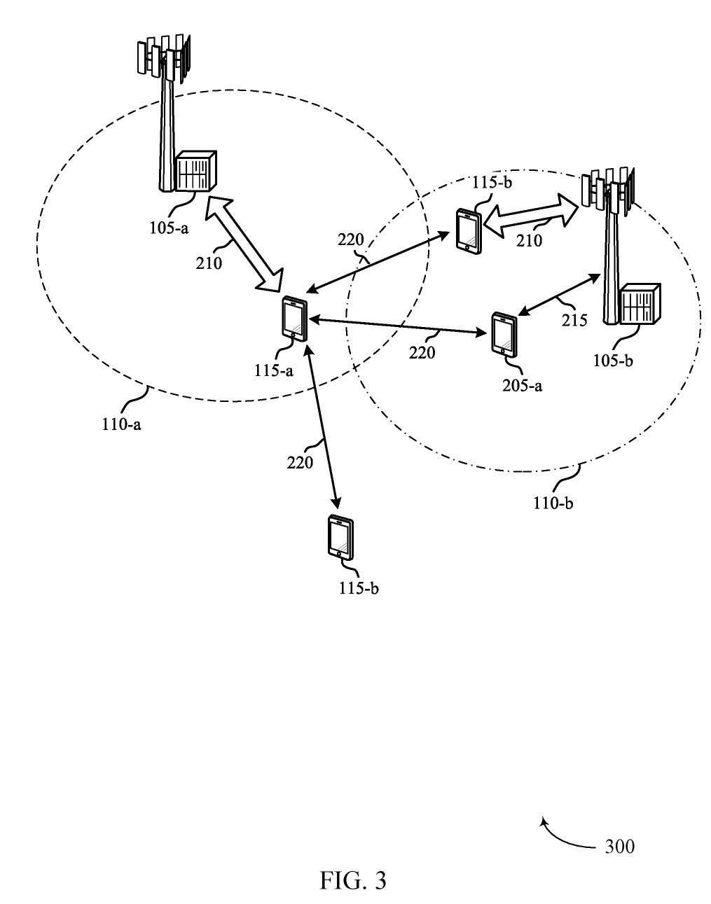

FIG. 3 illustrates an example of a wireless communications system 300 that supports UE power optimization in mmW access networks in accordance with various aspects of the present disclosure. Wireless communications system 300 includes base stations 105 and UEs 115 each of which may be an example of the corresponding devices as described with reference to FIGS. 1 and 2. Wireless communications system 300 also includes wireless device 205-a.

Wireless communications system 300 may be an example of wireless communications system 200 as described with reference to FIG. 2. In this example, wireless device 205-a may be a UE. Wireless device 205-a may be in communication with base station 105-b operating in NR. The UE 115-a may have its NR radio components powered off to conserve power and may be camped in LTE Idle mode. UE 115-a and Wireless device 205-a may be communicating via D2D communications (e.g., LTE-Direct (LTE-D)). Both wireless device 205-a and 115-a may be mobile. In some cases, LTE D2D UEs (e.g., wireless device 205-a and UE 115-a) may be in an RRC-CONNECTED mode or an RRC-IDLE mode, if authorized by the network. In other cases, LTE D2D UEs (e.g., wireless device 205-a and UE 115-a) may be in a scheduled mode, where the transmitting D2D UE may be RRC-CONNECTED

Wireless device 205-a may be used to indicated the presence of the wireless network of base station 105-b to UE 115-a. UE 115-a may be beyond a threshold distance to receive an indication directly from base station 105-b. Wireless device 205-a may closer in distance to UE 115-a than base station 105-b, and Wireless device 205-a may be within the threshold distance of UE 115-a to communicate via D2D communications. By sending an indication of the wireless network from UEs across the coverage area 110-a, a larger geographic area may be informed of the nearby NR network than the coverage area of 110-a.

UE 115-a may receive more than one D2D communications indicated the presence of base station 105-b. When UE 115-a receives an indication of the NR network of base station 105-b and determines to search for the NR network, UE 115-a may power on NR radio components. For example, a radio receive chain to listen for periodic synchronization signals, beam references, system information, etc., as part of an access procedure to connect to base station 105-b. The UE 115-a may then proceed to perform initial access procedures using the beam ID and base station ID.

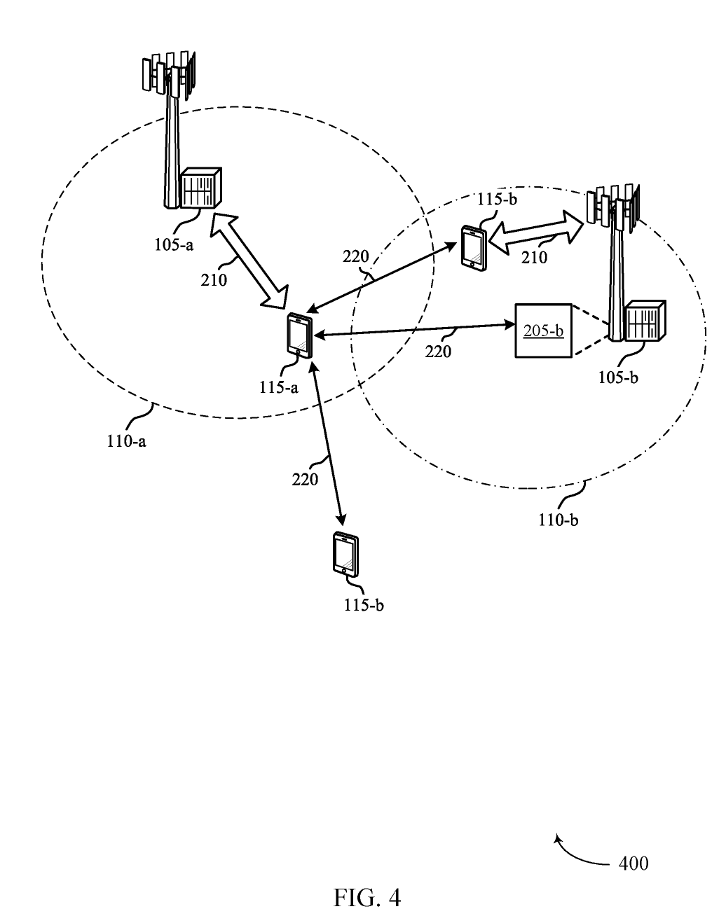

FIG. 4 illustrates an example of a wireless communications system 400 that supports UE power optimization in mmW access networks in accordance with various aspects of the present disclosure. Wireless communications system 400 includes base stations 105 and UEs 115 each of which may be an example of the corresponding devices as described with reference to FIGS. 1 and 2. Wireless communications system 400 also includes wireless device 205-b.

Wireless communications system 400 may be an example of wireless communications system 200 as described with reference to FIG. 2. In this example, wireless device 205-b may be fixed location, collocated, or embedded in base station 105-b. Wireless device 205-a may also be a device capable of acting as a UE (e.g., using some of the same or similar communications protocols as a UE 115) to perform D2D communications with other UEs, and therefore, allow the base station 105-b to emulate or present itself as a UE 115. The wireless network of base station 105-b may operate using a RAT that is different from the UE 115 that the base station 105-b is emulating. For example, base station 105-b may operate according to NR protocols and procedures, while the UE emulated by base station 105-b may communicate using LTE protocols and procedures, including for example LTE-D. UE 115-a may have its NR radio components powered off (e.g., in a sleep or idle state) to conserve power. UE 115-a and wireless device 205-b may communicate via D2D communications (e.g., LTE-Direct (LTE-D)). In some cases where base station 105-b supports emulation of a UE communicating using LTE protocols and procedures as described herein (e.g., including LTE-Direct (LTE-D)), base station 105 may be considered to be an NR-only device in some cases, and may be or be considered to be a dual mode device in other cases.

Wireless device 205-b may be used by base station 105-b to indicate the presence of the wireless network of base station 105-b to other wireless devices, including UE 115-a. Although UE 115-a may be within a threshold distance to receive an indication directly from base station 105-b, UE 115-a may not be aware of the network and to preserve battery may not have powered on its NR radio components. Wireless device 205-b may indicate to any UE capable of D2D communications the presence of NR base station 105-b. By sending an indication of the wireless network from the base station 105-b, a physical connection between the NR network and the D2D indication can be used to provide reliable information about the base station 105-b, and the embedded wireless device 205-b ensures autonomous D2D indications will always be present even when a UE is not searching, camped or communicating on the 105-a network.

UE 115-a may receive more than one D2D communications indicating the presence of base station 105-b. For example, wireless device 205-b and one or more UEs 115-b may send an indication that is received by UE 115-a. When UE 115-a receives one or more indications of the NR network of base station 105-b and determines to search for the NR network, UE 115-a may power on radio components supporting NR communications. For example, UE 115-a may power on radio components of a receive chain to listen for NR synchronization signals. In some cases, the UE 115-a will wait for a subsequent indication of the NR network after receiving a first indication in order to confirm the presence of the NR network. In some examples, UE 115-a may also use the first RAT via base station 105-a to survey the NR data base, for example for information about the NR network 110b of base station 105-b. The UE 115-a may then proceed to perform synchronization and begin initial access procedures using the beam ID and base station ID.

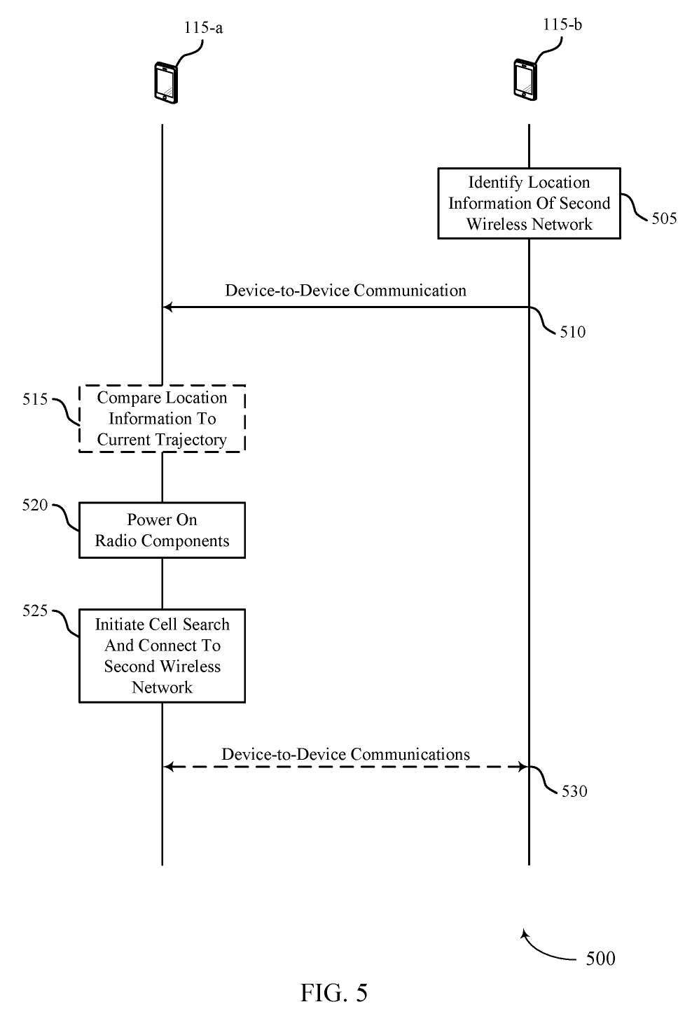

FIG. 5 shows a call flow diagram 500 illustrating operations and communications between UEs 115 in a wireless communication system, in accordance with various aspects of the present disclosure. The call flow diagram 500 may illustrate aspects of wireless communications systems 100, 200, or 300 described with reference to FIG. 1, 2, or 3, respectively. The call flow diagram 500 includes UE 115-a and UE 115-b. UE 115-a may be an example of one or more UEs 115 and 115-a described above with respect to FIGS. 1, 2, and 3. UE 115-b may be an example of one or more UEs 115, UEs 115-b, wireless device 205, or and wireless device 205-a described above with respect to FIGS. 1, 2, and 3. In some examples, UE 115-a may be in communication with a first wireless network using a first RAT (e.g., LTE), and UE 115-b may indicate the presence of a second wireless network using a second RAT (e.g., NR, or another RAT different than the first RAT). The call flow diagram 500 illustrates aspects of device-to-device communications between UEs 115 that allow UE 115-a to optimize when to wake up the radio chain, efficiently search for the second wireless network and consume any additional power. In some examples, a system device, such as one of UE 115-a or UE 115-b may execute one or more sets of codes to control the functional elements of the device to perform some or all of the functions and features described below.

At block 505, UE 115-b may identify the location information of the second wireless network. The location information may include one or more of the locations (relative or exact) of the UE 115-b, the mobility information of UE 115-b, the location (relative or exact) of the base station of the second wireless network, the coverage location (relative or exact) of the base station of the second wireless network, the signal strength of a link from base station of the second wireless network, the beam ID of that link, and the base station ID of base station of the second wireless network. UE 115-b may determine its location (relative or exact) in proximity to 105-b from information by measuring one or more received signals (e.g., a reference signal and a system information signal) from the base station of the second wireless network. In some cases, the base station of the second wireless network may convey location information to the UE 115-b. The location information may be stored at the UE 115-b such that the UE 115-b may continue to use the information after the UE 115-b is no longer located where the location information was determined. For example, UE 115-b may no longer be communicating with the base station of the second wireless network.

UE 115-b may transmit a device-to-device communication 510, for example an LTE-D sidelink communication conveying the location information. The device-to-device communication 510 may be received by UEs within a range class of proximity to UE 115-b, including UE 115-a. The range that UE 115-b can transmit device-to-device communication 510 may in some cases extend at least partially beyond the coverage area of the second wireless network. By way of example, UE 115-b may act as a relay of information for the base station of the second wireless network to UEs beyond the coverage area of the second wireless network base station. In some cases, the device-to-device communication 510 may be transmitted periodically. The device-to-device communication 510 may be or operate as a power efficient LTE-D communication (e.g., an LTE-D expression) as described above with reference to FIG. 1.

At optional block 515, UE 115-a may compare the received location information from multiple proximate device-to-device communications 510 to the current trajectory (e.g., position and speed) of UE 115-a to determine if UE 115-a will be within a threshold distance of UE 115-b and thus, potentially within the second wireless network. As also further discussed above, a coverage area 110b may be concentric (e.g., completely concentric) without a common origin, overlapping, or independent of coverage a coverage area 110-a associated with a first RAT. If UE 115-a determines that its trajectory will not be within the threshold distance of UE 115-b, UE 115-a may keep the radio components of the second RAT turned off UE 115-a may reevaluate searching for the second wireless network if a subsequent indication is received (e.g., via a device-to-device communication 510). When UE 115-a determines that it is within the threshold distance of UE 115-b, the UE 115-a may proceed to block 520.

At block 520, UE 115-a may power on one or more radio components of the second RAT. For example, if the second RAT is mmW, UE 115-a may power on its mmW modem, a mmW receive chain, applications processor, and other components for searching and acquiring the mmW network. UE 115-a may initially turn on receive components of UE 115-a used to support communications using the second RAT to verify information on the existence of coverage locations and/or reliability of the second network before powering on transmit components on the second RAT. In another case, UE 115-a may turn on both transmit and receive components for the second RAT at the same time depending on the implementation.

At block 525, after receiver wake up, UE 115-a may begin searching for the cell of the second wireless network using the radio components powered on at block 520. As part of searching for the cell, UE 115-a may start initial access procedures for reference symbol detection, synchronization, cell ID, beam ID, etc., for full cell acquisition with the second wireless network. UE 115-a may then become frame synchronized and connected to the second wireless network after a successful access procedure (e.g., a random access procedure such as a RACH procedure).

Optional device-to-device communications 530 may be used to continue to transmit location information to or from each of UE 115-a and UE 115-b to improve connectivity decisions for one or both of UE 115-a and UE 115-b. For example, UE 115-a may continue to monitor for device-to-device communications from UE 115-b, and UE 115-b may continue to transmit periodic device-to-device communications that may be used by UE 115-a to identify a location (e.g., coverage area) of the second RAT.

In another example, optional device-to-device communications 530 may be used by one or more of UE 115-a or UE 115-b to build a crowd sourced map of the coverage area of the second network. The crowd-sourced map may be maintained by UE 115-a or 115-b, and may be a database, table, or similar, that provides associations between base stations, sector cells, and/or coverage areas and location information. As such, the crowd sourced map may include information obtained from multiple different UEs 115 regarding base stations and/or coverage areas associated with the second RAT, for example one or more of time, location (e.g., latitude/longitude) information, signal strength, or cell or other ID information collected by various UEs over time.

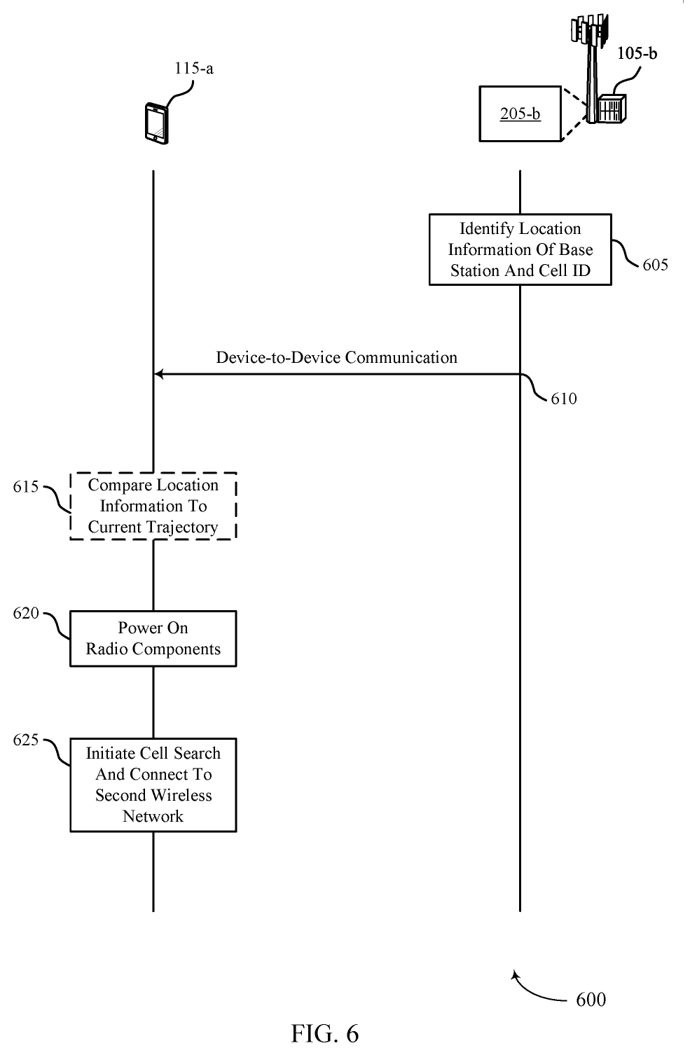

FIG. 6 illustrates shows a call flow diagram 600 illustrating operations and communications between UEs 115 in a wireless communication system, in accordance with various aspects of the present disclosure. The call flow diagram 600 may illustrate aspects of wireless communications systems 100, 200, or 400 described with reference to FIG. 1, 2, or 4, respectively. The call flow diagram 600 includes UE 115-a and wireless device 205-b, which may be embedded in base station 105-b and configured for device-to-device communication. UE 115-a may be an example of one or more UEs 115 and 115-a described above with respect to FIGS. 1, 2, and 4. Wireless device 205-b may be an example of one or more of wireless device 205 and wireless device 205-b described above with respect to FIGS. 2 and 4. In some examples, UE 115-a may be in communication with a first wireless network using a first RAT (e.g., LTE), and wireless device 205-b may indicate the presence of a second wireless network using a second RAT (e.g., NR). The call flow diagram 600 illustrates aspects of device-to-device communications between UE 115-a and wireless device 205-b that allow UE 115-a to optimize when to wake up the radio chain, efficiently search for the second wireless network and consume any additional power. In some examples, a system device, such as one of UE 115-a or wireless device 205-b may execute one or more sets of codes to control the functional elements of the device to perform some or all of the functions described below.

At block 605, wireless device 205-b may identify the location information of the second wireless network. The location information may include one or more of the location (relative or exact) of the base station 105-b of the second wireless network, the coverage location (relative or exact) of the base station 105-b of the second wireless network, the signal strength of a link from base station 105-b of the second wireless network, the beam ID of that link, and the base station ID (e.g., a cell ID, group and sector ID, or other physical layer identifier) of base station 105-b.

Wireless device 205-b may transmit a device-to-device sidelink communication 610 (e.g., an LTE-D sidelink communication or NR D2D in future) to UEs within a proximity of base station 105-b (e.g., using a broadcast, multicast, or groupcast expression), including UE 115-a, conveying the location information. The range class that wireless device 205-b can transmit device-to-device communication 610 may be great than, similar to or less than the coverage area of the second wireless network. In other examples, the range may be controlled to a range (e.g., a concentric range) of the coverage area for base station 105-b in the second wireless network, for example because the base station 105-b may use wireless device 205 to transmit, as a collocated embedded device, according to D2D power limits and at sub-6 GHz frequencies that would be applicable to wireless device 205 as a standalone wireless device. The device-to-device communication 610 may be transmitted periodically (e.g., via scheduled or asynchronously transmissions) to signal the proximity of a base station 105-b. For example, according to the resource allocation mode for D2D communications to be sent in the first wireless network 205-b, which may be in coverage or out of coverage of the first RAT. In other example, the device-to-device communication 610 may be transmitted during each of a LTE-D communication discovery period, for example, as described above with reference to FIG. 1. In other examples, the device-to-device communication 610 may be sent in a subset of the discovery periods, for example according to a configured period to save power.

At optional block 615, UE 115-a may compare the received location information from device-to-device communication 610 (e.g., multiple proximate D2D communications) to location information for UE 115-a. For example, UE 115-a may compare the current trajectory (e.g., position and speed) of itself with the location information from device-to-device communication 610, for example for base station 105-b, to determine if UE 115-a will be within a threshold distance of wireless device 205-b or base station 105-b and thus, possibly within the second wireless network. If UE 115-a determines that its trajectory will not be within the threshold distance of wireless device 205-b or base station 105-b, UE 115-a may keep the radio components of the second RAT turned off, in a sleep or idle state, or operating in another lower-power state or mode. UE 115-a may determine to cease or delay searching for the second wireless network if a subsequent indication is received (e.g., via a device-to-device communication 610).

In other examples, UE 115-a may begin searching for the second RAT and listening for broadcast transmissions from base station 105-b so that UE 115-a may begin a normal connection procedure (e.g., a random access procedure) if UE 115-a determines that it is within a threshold distance of wireless device 205-b using a priori sidelink location information or alternatively directly from the first RAT mode if present on base station 105-b and thus is or may be soon, within a coverage area of the second wireless network using the second RAT. A UE 115-a may know based on the received location information that it is within the coverage area of the second wireless network. When UE 115-a determines that it is within the threshold distance of wireless device 205-b or base station 105-b, the UE 115-a may proceed to block 620.

At block 620, UE 115-a may power on one or more radio components of the second RAT. For example, if the second RAT is 5G, UE 115-a may power on its modem, receive chain, transmit chain, applications processor, or other components for searching and acquiring the network using the second RAT (e.g., a 5G NR mmW network). UE 115-a may initially turn on receive components of the second RAT to verify information on the existence of coverage locations and/or reliability of the second network before powering on transmit components of UE 115-a used to support the second RAT. In another case, UE 115-a may turn on both transmit and receive components for the second RAT at the same time depending on the implementation.

At block 625, after receiver wake up, UE 115-a may begin searching for the cell of the second wireless network (e.g., for broadcasts from base station 105-b identifying the cell of the second wireless network) using the radio components powered on at block 620. As part of searching for the cell, UE 115-a may start initial access procedures for reference symbol detection, synchronization, cell ID, beam ID, etc., for full cell acquisition with the second wireless network. UE 115-a may then become frame synchronized and connected to the second wireless network after a successful access procedure (e.g., random access procedure).

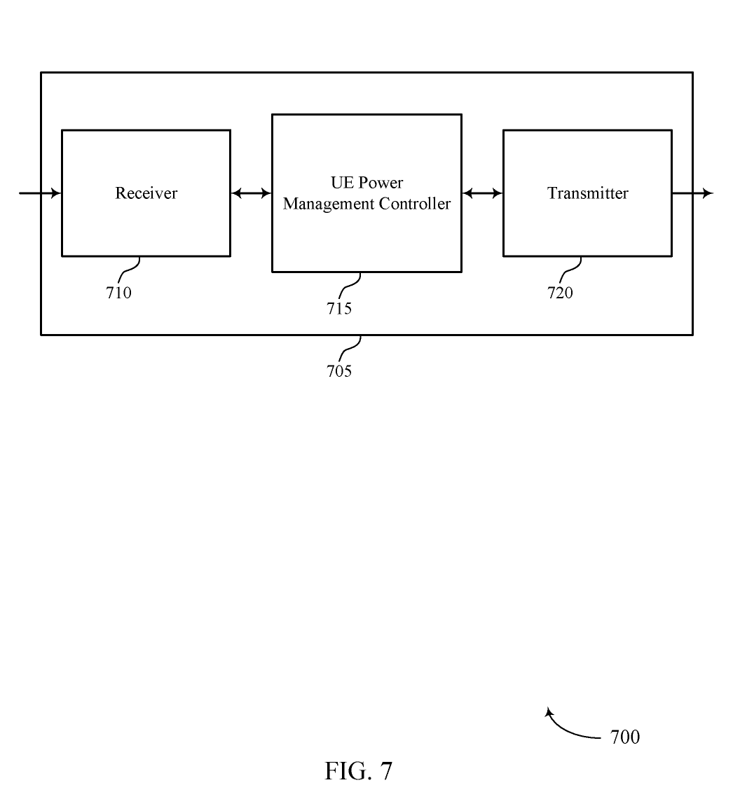

FIG. 7 shows a block diagram 700 of a wireless device 705 that supports UE power optimization in mmW access networks in accordance with aspects of the present disclosure. Wireless device 705 may be an example of aspects of a UE 115 and UE 115-a as described herein. Wireless device 705 may include receiver 710, UE power management controller 715, and transmitter 720. Wireless device 705 may also include a processor. Each of these components may be in communication with one another (e.g., via one or more buses).

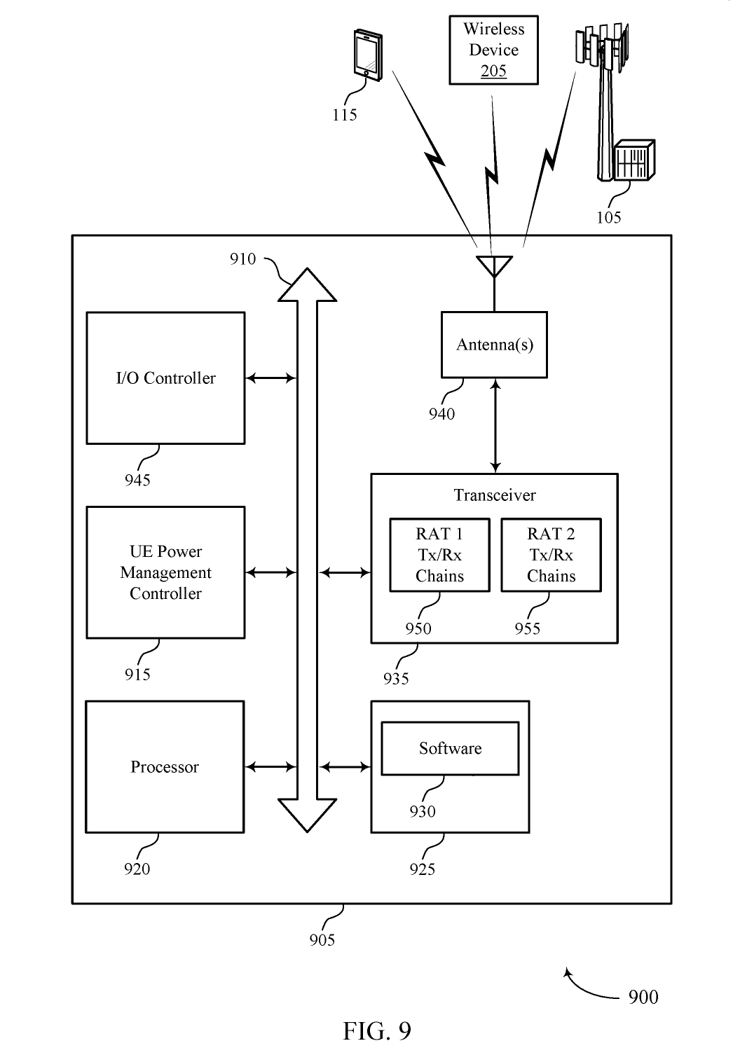

Receiver 710 may receive information such as timing references, broadcast packets, user data, or control information associated with various information channels (e.g., control channels, data channels, and information related to determining the state of the UE communications, and the opportunity for power optimization in mmW access networks, etc.). Information may be passed on to other components of the device (e.g., including UE power management controller 915). The receiver 710 may be an example of aspects of the transceiver 735 described with reference to FIG. 9. The receiver 710 may utilize a single antenna or a set of antennas.

Receiver 710 may listen for a device-to-device communication of a first wireless network using a first RAT, the UE in an idle or deep sleep power off state for a second RAT, receives the device-to-device communication using the first RAT, the device-to-device communication including location information such as the proximity of a base station of a second wireless network. The UE may receive one or more additional informative device-to-device communications from one or more additional UEs, each of the one or more additional device-to-device communications including additional location information for the base station of the second wireless network, and receive, from a set of additional UEs, location information for base stations of the second wireless network. In some cases, receiving the device-to-device communication may include receiving the device-to-device communication from a second UE using the first RAT (or device to device from a second UE using the second RAT.

In some cases, receiving the device-to-device communication may include receiving the device-to-device communication from the base station of the second wireless network, the device-to-device communication formatted as a UE transmission. In some cases, listening for the device-to-device communication may include periodically listening for the device-to-device communication during a predetermined time interval for discovery of UEs transmitting device-to-device communications. In some cases, listening for the device-to-device communication using the first RAT may include waking up the first RAT radio to listen for the device-to-device communication when camped in an idle state for the first RAT. In some cases, listening for the device-to-device communication using the first RAT further may include listening for the device-to-device communication when already in an active state (e.g., power on state) for the first RAT.

UE power management controller 715 may be an example of aspects of the UE power management controller 915 described with reference to FIG. 9.

UE power management controller 715 and/or at least some of its various sub-components may be implemented in hardware, software executed by a processor, firmware, or any combination thereof. If implemented in software executed by a processor, the functions of the UE power management controller 715 and/or at least some of its various sub-components may be executed by a general-purpose processor, a digital signal processor (DSP), an application-specific integrated circuit (ASIC), an field-programmable gate array (FPGA) or other programmable logic device, discrete gate or transistor logic, discrete hardware components, or any combination thereof designed to perform the functions described in the present disclosure. The UE power management controller 715 and/or at least some of its various sub-components may be physically located at various positions, including being distributed such that portions of functions are implemented at different physical locations by one or more physical devices. In some examples, UE power management controller 715 and/or at least some of its various sub-components may be a separate and distinct component in accordance with various aspects of the present disclosure. In other examples, UE power management controller 715 and/or at least some of its various sub-components may be combined with one or more other hardware components, including but not limited to an I/O component, a transceiver, a network server, another computing device, one or more other components described in the present disclosure, or a combination thereof in accordance with various aspects of the present disclosure.

UE power management controller 715 may activate radio components, for example components of the second RAT, of the UE into an active state based on the location information for the base station of the second wireless network, the unique radio components configured to support communications using the second RAT and to initiate a cell search procedure using such activated radio components.

Transmitter 720 may transmit signals generated by other components of the device. In some examples, the transmitter 720 may be collocated with a receiver 710 in a transceiver module. For example, the transmitter 720 may be an example of aspects of the transceiver 935 described with reference to FIG. 9. The transmitter 720 may utilize a single antenna or a set of antennas. In some cases, more transceiver chains may results in improved power management at a UE since mmW transmissions may be power inefficient due to low power amplifier efficiency.

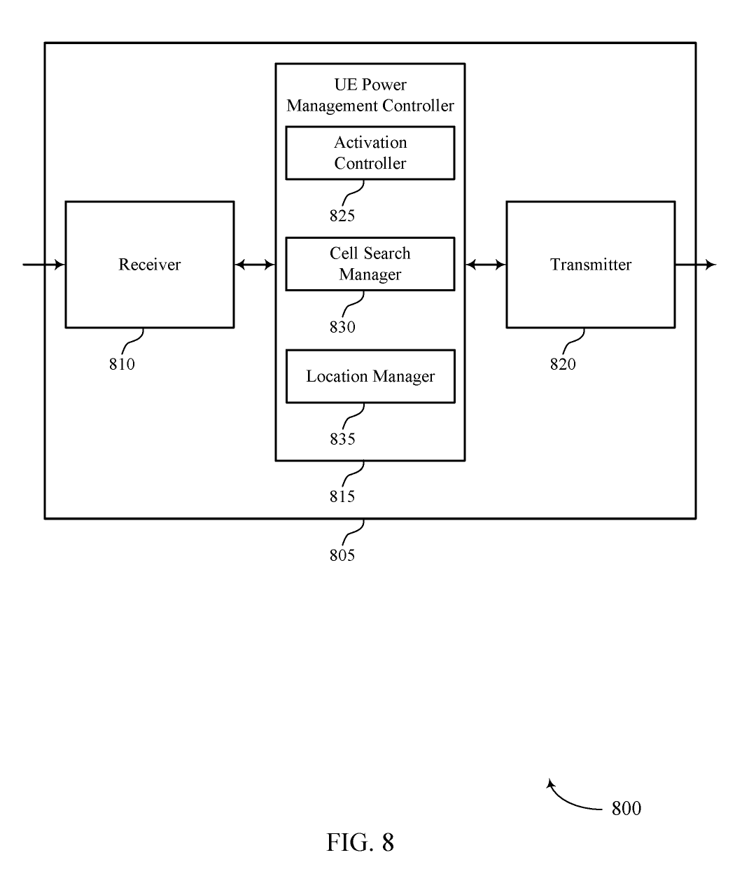

FIG. 8 shows a block diagram 800 of a wireless device 805 that supports UE power optimization in mmW access networks in accordance with aspects of the present disclosure. Wireless device 805 may be an example of aspects of a wireless device 705 or a UE 115 as described with reference to FIG. 7. Wireless device 805 may include receiver 810, UE power management controller 815, and transmitter 820. Wireless device 805 may also include a processor. Each of these components may be in communication with one another (e.g., via one or more buses).

Receiver 810 may receive information such as timing references, broadcast packets, user data, or control information associated with various information channels (e.g., control channels, data channels, and information related to determining the state of the UE communications, and the opportunity for power optimization in mmW access networks, etc.). Information may be passed on to other components of the device. The receiver 810 may be an example of aspects of the transceiver 935 described with reference to FIG. 9. The receiver 810 may utilize a single antenna or a set of antennas.

UE power management controller 815 may be an example of aspects of the UE power management controller 915 described with reference to FIG. 9. UE power management controller 815 may also include activation controller 825 and cell search manager 830.

Activation controller 825 may activate radio components of the UE into an active state based on the location information for the base station of the second wireless network, the radio components configured to support communications using the second RAT. This information may be available from dynamic, locally stored location information data in the UE or obtained from the crowdsourced database in the network.

Cell search manager 830 may initiate a cell search procedure using the activated radio components and initiate the cell search procedure based on the determined distance or probability of signal coverage between the UE and the base station being less than a threshold.

Location manager 835 may identify a current location of the UE, determine a distance between the UE and the base station based on the location information for the base station and the current location of the UE, estimate a location of the base station of the second wireless network, or of a coverage area of the base station, or a combination thereof, based on the one or more additional device-to-device communications, and generate a database (e.g., locally cached or cloud based database) of base station locations for the second wireless network based on the received location information. In some cases, the location information includes coordinates for the UE and an indication of a measurement of a signal received at the UE from the base station (e.g., signal strength and/or signal level). In some case this information may periodically be sent to update a network wide database.

Transmitter 820 may transmit signals generated by other components of the device. In some examples, the transmitter 820 may be collocated with a receiver 810 in a transceiver module. For example, the transmitter 820 may be an example of aspects of the transceiver 935 described with reference to FIG. 9. The transmitter 820 may utilize a single antenna or a set of antennas.

FIG. 9 shows a diagram of a system 900 including a wireless device 905 that supports UE power optimization in mmW access networks in accordance with aspects of the present disclosure. Wireless device 905 may be an example of or include the components of wireless device 705, wireless device 805, or a UE 115 as described above, (e.g., with reference to FIGS. 7 and 8). Wireless device 905 may include components for bi-directional voice and data communications including components for transmitting and receiving communications, including UE power management controller 915, processor 920, memory 925, software 930, transceiver 935, antenna 940, and I/O controller 945. These components may be in electronic communication via one or more buses (e.g., bus 910). Wireless device 905 may communicate wirelessly with one or more base stations 105.

Processor 920 may include an intelligent hardware device, (e.g., a general-purpose processor, a DSP, a central processing unit (CPU), a microcontroller, an ASIC, an FPGA, a programmable logic device, a discrete gate or transistor logic component, a discrete hardware component, or any combination thereof). In some cases, processor 920 may be configured to operate a memory array using a memory controller. In other cases, a memory controller may be integrated into processor 920. Processor 920 may be configured to execute computer-readable instructions stored in a memory to perform various functions (e.g., functions or tasks supporting UE power optimization in mmW access networks).

Memory 925 may include random access memory (RAM) and read only memory (ROM). The memory 925 may store computer-readable, computer-executable software 930 including instructions that, when executed, cause the processor to perform various functions described herein. In some cases, the memory 925 may contain, among other things, a basic input/output system (BIOS) which may control basic hardware or software operation such as the interaction with peripheral components or devices.

Software 930 may include code to implement aspects of the present disclosure, including code to support UE power optimization in mmW access networks. Software 930 may be stored in a non-transitory computer-readable medium such as system memory or other memory. In some cases, the software 930 may not be directly executable by the processor but may cause a computer (e.g., when compiled and executed) to perform functions described herein.

Transceiver 935 may communicate bi-directionally, via one or more antennas, wired, or wireless links as described above. For example, the transceiver 935 may represent a wireless transceiver and may communicate bi-directionally with another wireless transceiver. The transceiver 935 may also include a modem to modulate the packets and provide the modulated packets to the antennas for transmission, and to demodulate packets received from the antennas.

Transceiver 935 may include multiple transmit chains and multiple receive chains to transmit and received using multiple different RATs, which may be in the same or different bands. For example, transceiver 935 may communicate in a sub-6 GHz network with an LTE used in a D2D operating mode. Transmit and receive chains 950 may be used to or configured to support communications according to a first RAT, and transmit and receive chains 955 may be used to or configured to support communications according to a second RAT. A transmit chain of one or both of transmit and receive chains 950 and transmit and receive chains 955 may include various components used to prepare communications for transmission, including one or more baseband processors, digital-to-analog converters (DAC), mixers, filters, and amplifiers (e.g., power amplifiers (PA), etc.). A receive chain of one or both of transmit and receive chains 950 and transmit and receive chains 955 may include various components used to receive communications, including one or more filters, amplifiers (e.g., low noise amplifiers (LNA), etc.), analog-to-digital converters (ADC), mixers, baseband processors, etc. According to examples described herein, UE power management controller 915 may operate to turn one or more of these components, or portions of these components, on or off to save power according to the techniques described herein. For example, wireless device 905 may listen for device-to-device communication of a first wireless network using transmit and receive chains 950, while transmit and receive chains 955 are powered down in an idle state. After receiving location information in the device-to-device communication using a receive chain of the transmit and receive chains 950 for the first RAT, the UE power management controller 915 may activate transmit and receive chains 955 for the second RAT into an active state, so that wireless device 905 may communicate using the second RAT. For example, wireless device 905 may determine to initiate a cell search procedure for a cell of the second RAT using transmit and receive chains 955 after they are activated.

In some cases, the wireless device may include a single antenna 940. However, in some cases the device may have more than one antenna 940 with or without an integrated module to support the mmW array, which may be capable of beamforming and concurrently transmitting or receiving multiple wireless transmissions. In some examples, transmit and receive chains 950 for the first RAT and transmit and receive chains 955 for the second RAT may use the same antenna, antenna array, or other common set of antenna. In other examples, transmit and receive chains 950 for the first RAT and transmit and receive chains 955 for the second RAT may use different antennas or antenna arrays.

I/O controller 945 may manage input and output signals for wireless device 905. I/O controller 945 may also manage peripherals not integrated into wireless device 905. In some cases, I/O controller 945 may represent a physical connection or port to an external peripheral. In some cases, I/O controller 945 may utilize an operating system such as iOS®, ANDROID®, MS-DOS®, MS-WINDOWS®, OS/2®, UNIX®, LINUX®, or another known operating system. In other cases, I/O controller 945 may represent or interact with a modem, a keyboard, a mouse, a touchscreen, or a similar device. In some cases, I/O controller 945 may be implemented as part of a processor. In some cases, a user may interact with wireless device 905 via I/O controller 945 or via hardware components controlled by I/O controller 945.

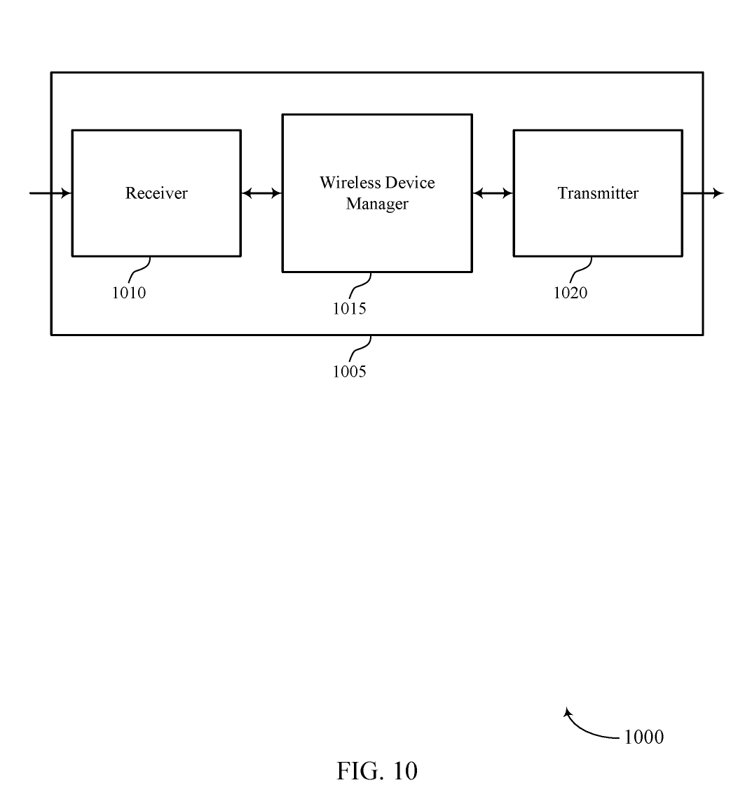

FIG. 10 shows a block diagram 1000 of a wireless device 1005 that supports UE power optimization in mmW access networks in accordance with aspects of the present disclosure. Wireless device 1005 may be an example of aspects of a wireless device 205 as described herein. Wireless device 1005 may include receiver 1010, wireless device manager 1015, and transmitter 1020. Wireless device 1005 may also include a processor. Each of these components may be in communication with one another (e.g., via one or more buses).

In some cases wireless device 1005 may be an example of a wireless device 205 as further described above with reference to FIGS. 2-6. For example it may be a LTE D2D-enabled device, or may support other beacon device technology, for examples including Bluetooth, Wi-Fi, etc., as further described above with reference to FIGS. 2-6. It may be placed in a coverage area to signal to proximate UEs 115 the level of mmW NR coverage, so that such proximate UEs 115 may turn on their NR radios. Wireless device 1005 may act as a relay, an may be fixed, not battery constrained, and supporting sustained connections to a base station 105-b via a second RAT (e.g., may be dual mode). Alternatively or additionally, wireless device 1005 may be collocated with the base station 105-b, and be capable of communicating using a second RAT that gets NR information directly via wired bus. As such, in some cases wireless device 1005 may reflect a cheaper or more efficient way to send location information via LTE 4G D2D. In some examples wireless device 1005 may be non-collocated with base station 105-b and behave in some aspects as a repeater or sensor to sense the NR location information and provide assistance to power manage and alert proximate UEs 115 as they enter mmW coverage areas via lower power out of band or sideband technology, for example LTE D2D, Bluetooth, or Wi-Fi. In some cases wireless device 1005 or wireless device 205 may be fixed with or without an NR radio depending on the independent or collocated use case, as further described herein. In some cases, wireless device 205 may be mobile and obtain NR location information from other UEs 115.

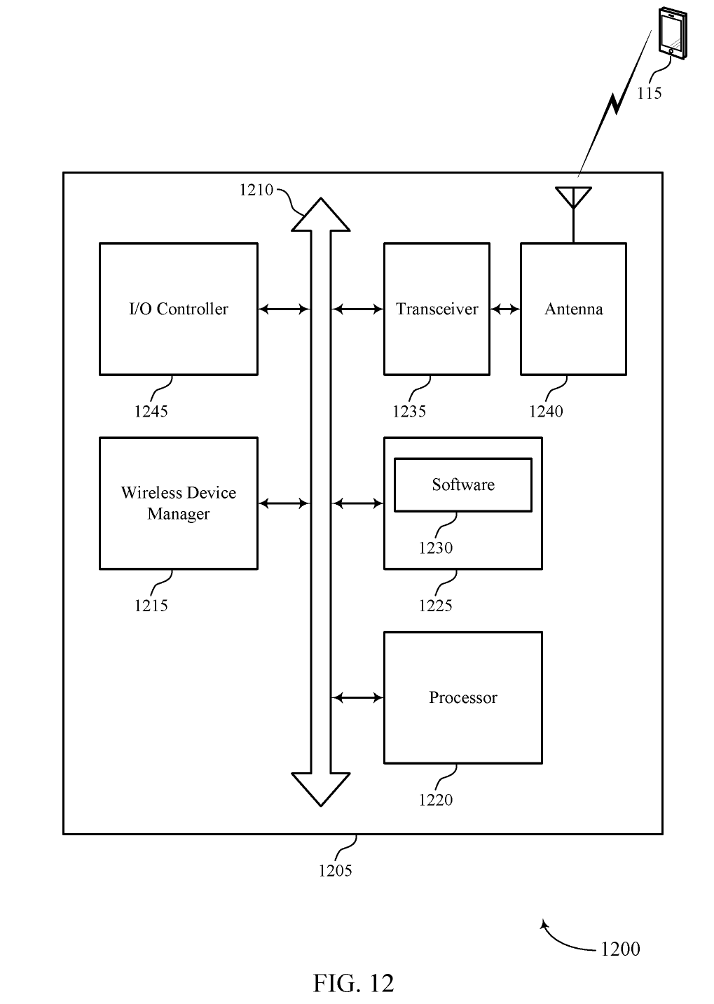

Receiver 1010 may receive information such as timing references, broadcast packets, user data, or control information associated with various information channels (e.g., control channels, data channels, and information related to determining the state of the UE communications, and the opportunity for power optimization in mmW access networks, etc.). Information may be passed on to other components of the device. The receiver 1010 may be an example of aspects of the transceiver 1235 described with reference to FIG. 12. The receiver 1010 may utilize a single antenna or a set of antennas.

Receiver 1010 may receive signals from the base station of the second wireless network. In some cases, identifying the location information for the second wireless network may include receiving, at the first wireless device, one or more signals from the base station of the second wireless network using the first RAT.

Wireless device manager 1015 may be an example of aspects of the wireless device manager 1215 described with reference to FIG. 12.

Wireless device manager 1015 and/or at least some of its various sub-components may be implemented in hardware, software executed by a processor, firmware, or any combination thereof If implemented in software executed by a processor, the functions of the wireless device manager 1015 and/or at least some of its various sub-components may be executed by a general-purpose processor, a DSP, an ASIC, an FPGA or other programmable logic device, discrete gate or transistor logic, discrete hardware components, or any combination thereof designed to perform the functions described in the present disclosure. The wireless device manager 1015 and/or at least some of its various sub-components may be physically located at various positions, including being distributed such that portions of functions are implemented at different physical locations by one or more physical devices. In some examples, wireless device manager 1015 and/or at least some of its various sub-components may be a separate and distinct component in accordance with various aspects of the present disclosure. In other examples, wireless device manager 1015 and/or at least some of its various sub-components may be combined with one or more other hardware components, including but not limited to an I/O component, a transceiver, a network server, another computing device, one or more other components described in the present disclosure, or a combination thereof in accordance with various aspects of the present disclosure.

Wireless device manager 1015 may identify, by a first wireless device configured to communicate in a first wireless network using a first RAT, location information for a base station of a second wireless network using a second RAT.

Transmitter 1020 may transmit signals generated by other components of the device. In some examples, the transmitter 1020 may be collocated with a receiver 1010 in a transceiver module. For example, the transmitter 1020 may be an example of aspects of the transceiver 1235 described with reference to FIG. 12. The transmitter 1020 may utilize a single antenna or a set of antennas.

Transmitter 1020 may transmit, using the first RAT or the second RAT, a device-to-device communication from the first wireless device to a UE, the device-to-device communication including the location information for the base station of the second wireless network.

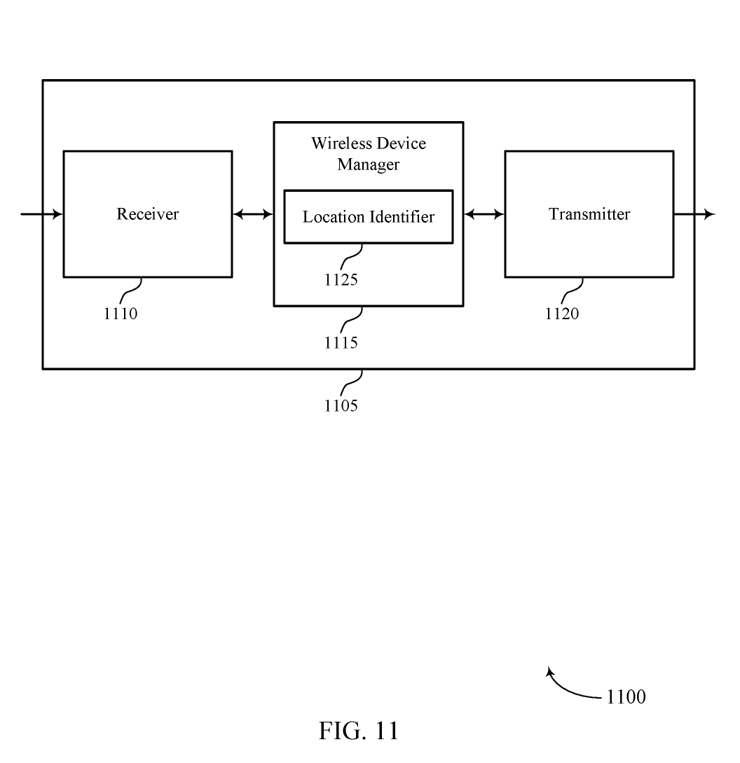

FIG. 11 shows a block diagram 1100 of a wireless device 1105 that supports UE power optimization in mmW access networks in accordance with aspects of the present disclosure. Wireless device 1105 may be an example of aspects of a wireless device 1005 or a wireless device 205 as described with reference to FIG. 10. Wireless device 1105 may include receiver 1110, wireless device manager 1115, and transmitter 1120. Wireless device 1105 may also include a processor. Each of these components may be in communication with one another (e.g., via one or more buses).

Receiver 1110 may receive information such as timing references, broadcast packets, user data, or control information associated with various information channels (e.g., control channels, data channels, and information related to determining the state of the UE communications, and the opportunity for power optimization in mmW access networks, etc.). Information may be passed on to other components of the device. The receiver 1110 may be an example of aspects of the transceiver 1235 described with reference to FIG. 12. The receiver 1110 may utilize a single antenna or a set of antennas.

Wireless device manager 1115 may be an example of aspects of the wireless device manager 1215 described with reference to FIG. 12. Wireless device manager 1115 may also include location identifier 1125.

Location identifier 1125 may identify, by a first wireless device configured to communicate in a first wireless network using a first RAT, location information for a base station of a second wireless network using a second RAT, determine the location (or coverage) information for the base station based on the one or more signals, and measure a signal transmitted by the base station of the second wireless network, where the location information includes coordinates for the first wireless device and an indication of the measured signal.

In some cases, the one or more signals from the base station include a system information signal of the base station, or a reference signal transmitted by the base station, or a combination thereof. In some cases, the base station of the second wireless network includes the first wireless device, the base station configured to transmit the device-to-device communication formatted as a UE transmission. In some cases, the first wireless device includes a UE embedded in the base station to transmit the device-to-device communication as the UE transmission. In some cases, the location information includes coordinates for the base station of the second wireless network, or for an expected coverage area of the base station, or a combination thereof

Transmitter 1120 may transmit signals generated by other components of the device. In some examples, the transmitter 1120 may be collocated with a receiver 1110 in a transceiver module. For example, the transmitter 1120 may be an example of aspects of the transceiver 1235 described with reference to FIG. 12. The transmitter 1120 may utilize a single antenna or a set of antennas.

FIG. 12 shows a diagram of a system 1200 including a device 1205 that supports UE power optimization in mmW access networks in accordance with aspects of the present disclosure. Device 1205 may be an example of or include the components of wireless device 205 as described above (e.g., with reference to FIG. 2). Device 1205 may include components for bi-directional voice and data communications including components for transmitting and receiving communications, including wireless device manager 1215, processor 1220, memory 1225, software 1230, transceiver 1235, antenna 1240, and I/O controller 1245. These components may be in electronic communication via one or more buses (e.g., bus 1210).

Processor 1220 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, processor 1220 may be configured to operate a memory array using a memory controller. In other cases, a memory controller may be integrated into processor 1220. Processor 1220 may be configured to execute computer-readable instructions stored in a memory to perform various functions (e.g., functions or tasks supporting UE power optimization in mmW access networks).

Memory 1225 may include RAM and ROM. The memory 1225 may store computer-readable, computer-executable software 1230 including instructions that, when executed, cause the processor to perform various functions described herein. In some cases, the memory 1225 may contain, among other things, a BIOS which may control basic hardware or software operation such as the interaction with peripheral components or devices.

Software 1230 may include code to implement aspects of the present disclosure, including code to support UE power optimization in mmW access networks. Software 1230 may be stored in a non-transitory computer-readable medium such as system memory or other memory. In some cases, the software 1230 may not be directly executable by the processor but may cause a computer (e.g., when compiled and executed) to perform functions described herein.

Transceiver 1235 may communicate bi-directionally, via one or more antennas, wired, or wireless links as described above. For example, the transceiver 1235 may represent a wireless transceiver and may communicate bi-directionally with another wireless transceiver. The transceiver 1235 may also include a modem to modulate the packets and provide the modulated packets to the antennas for transmission, and to demodulate packets received from the antennas.

In some cases, the wireless device may include a single antenna 1240. However, in some cases the device may have more than one antenna 1240, which may be capable of concurrently transmitting or receiving multiple wireless transmissions.

I/O controller 1245 may manage input and output signals for device 1205. I/O controller 1245 may also manage peripherals not integrated into device 1205. In some cases, I/O controller 1245 may represent a physical connection or port to an external peripheral. In some cases, I/O controller 1245 may utilize an operating system such as iOS®, ANDROID®, MS-DOS®, MS-WINDOWS®, OS/2®, UNIX®, LINUX®, or another known operating system. In other cases, I/O controller 1245 may represent or interact with a modem, a keyboard, a mouse, a touchscreen, or a similar device. In some cases, I/O controller 1245 may be implemented as part of a processor. In some cases, a user may interact with device 1205 via I/O controller 1245 or via hardware components controlled by I/O controller 1245.

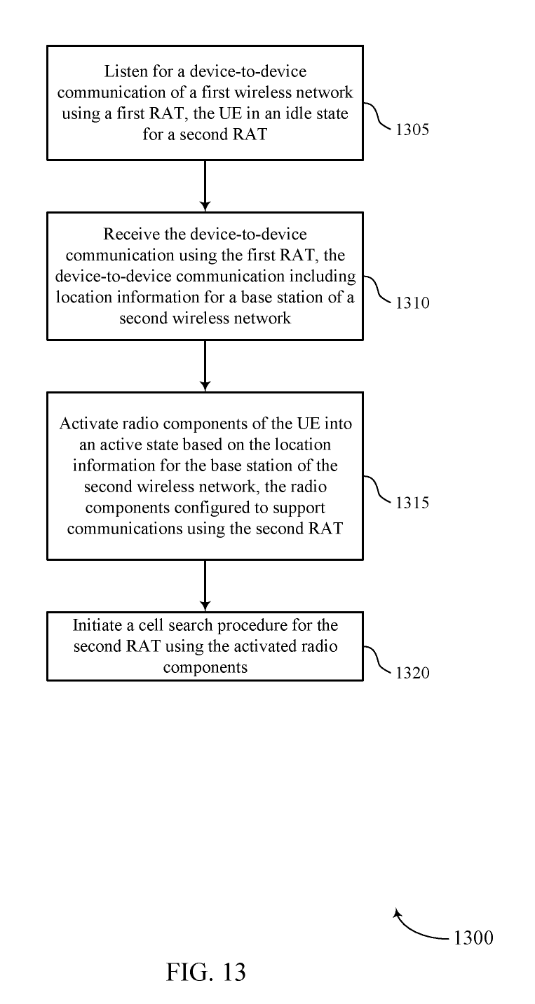

FIG. 13 shows a flowchart illustrating a method 1300 for UE power optimization in mmW access networks in accordance with aspects of the present disclosure. The operations of method 1300 may be implemented by a UE 115 or its components as described herein. For example, the operations of method 1300 may be performed by a UE power management controller as described with reference to FIGS. 7 through 9. In some examples, a UE 115 may execute a set of codes (e.g., firmware code) to control the functional elements of the device to perform the functions described below. Additionally or alternatively, the UE 115 may perform aspects of the functions described below using special-purpose hardware.

At 1305 the UE 115 may listen for a device-to-device communication of a first wireless network using a first radio access technology (RAT), the UE in an idle state for a second RAT. The operations of 1305 may be performed according to the methods described herein. In certain examples, aspects of the operations of 1305 may be performed by a receiver as described with reference to FIGS. 7 through 9.

At 1310 the UE 115 may receive the device-to-device communication using the first RAT, the device-to-device communication comprising location information for a base station of a second wireless network. The operations of 1310 may be performed according to the methods described herein. In certain examples, aspects of the operations of 1310 may be performed by a receiver as described with reference to FIGS. 7 through 9.

At 1315 the UE 115 may activate radio components of the UE into an active (e.g., power on) state based at least in part on the location information for the base station of the second wireless network, the radio components configured to support communications using the second RAT. The operations of 1315 may be performed according to the methods described herein. In certain examples, aspects of the operations of 1315 may be performed by a UE power management controller as described with reference to FIGS. 7 through 9.

At 1320 the UE 115 may initiate a cell search procedure for the second RAT using the activated radio components. The operations of 1320 may be performed according to the methods described herein. In certain examples, aspects of the operations of 1320 may be performed by a cell search manager as described with reference to FIGS. 7 through 9.

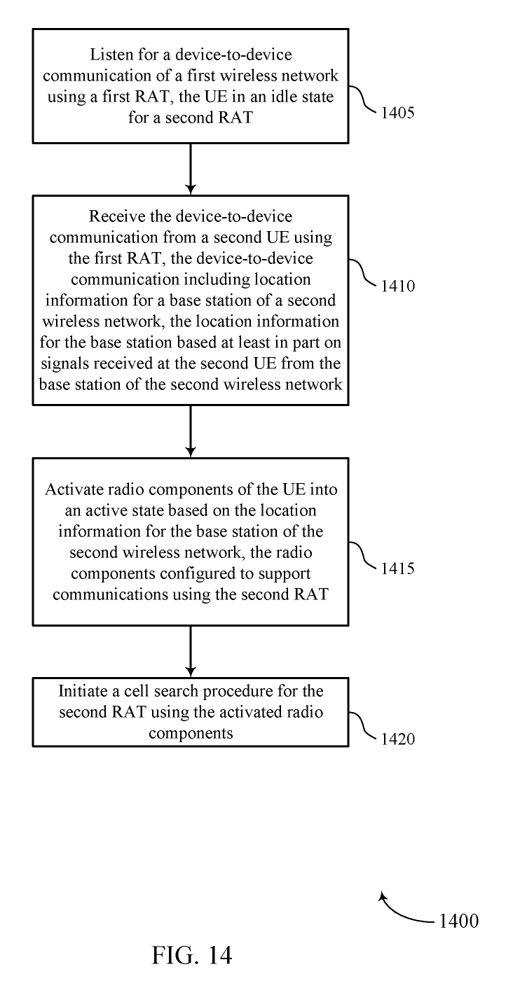

FIG. 14 shows a flowchart illustrating a method 1400 for UE power optimization in mmW access networks in accordance with aspects of the present disclosure. The operations of method 1400 may be implemented by a UE 115 or its components as described herein. For example, the operations of method 1400 may be performed by a UE power management controller as described with reference to FIGS. 7 through 9. In some examples, a UE 115 may execute a set of codes to control the functional elements of the device to perform the functions described below. Additionally or alternatively, the UE 115 may perform aspects of the functions described below using special-purpose hardware.

At 1405 the UE 115 may listen for a device-to-device communication of a first wireless network using a first radio access technology (RAT), the UE in an idle state for a second RAT. The operations of 1405 may be performed according to the methods described herein. In certain examples, aspects of the operations of 1405 may be performed by a receiver as described with reference to FIGS. 7 through 9.

At 1410 the UE 115 may receive the device-to-device communication from a second UE using the first RAT, the device-to-device communication including location information for a base station of a second wireless network, the location information for the base station is based at least in part on signals received at the second UE from the base station of the second wireless network. In some cases, the second UE may be a device directly wired and collocated with the base station of the second RAT. The operations of 1410 may be performed according to the methods described herein. In certain examples, aspects of the operations of 1410 may be performed by a receiver as described with reference to FIGS. 7 through 9.

At 1415 the UE 115 may activate radio components of the UE into an active state based at least in part on the location information for the base station of the second wireless network, the radio components configured to support communications using the second RAT. The operations of 1415 may be performed according to the methods described herein. In certain examples, aspects of the operations of 1415 may be performed by a power controller as described with reference to FIGS. 7 through 9.

At 1420 the UE 115 may initiate a cell search procedure for the second RAT using the activated radio components. The operations of 1420 may be performed according to the methods described herein. In certain examples, aspects of the operations of 1420 may be performed by a cell search manager as described with reference to FIGS. 7 through 9.

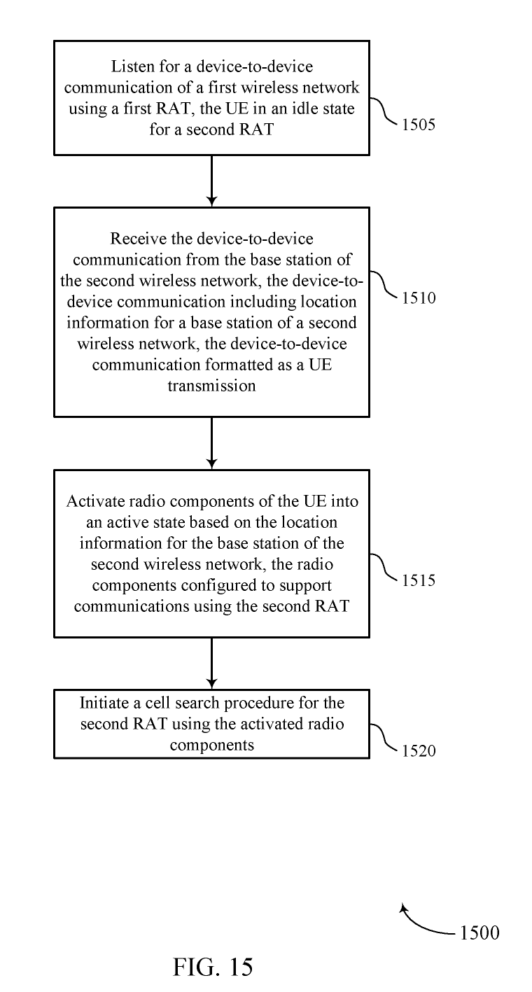

FIG. 15 shows a flowchart illustrating a method 1500 for UE power optimization in mmW access networks in accordance with aspects of the present disclosure. The operations of method 1500 may be implemented by a UE 115 or its components as described herein. For example, the operations of method 1500 may be performed by a UE power management controller as described with reference to FIGS. 7 through 9. In some examples, a UE 115 may execute a set of codes (e.g., firmware code) to control the functional elements of the device to perform the functions described below. Additionally or alternatively, the UE 115 may perform aspects of the functions described below using special-purpose hardware.

At 1505 the UE 115 may listen for a device-to-device communication of a first wireless network using a first RAT, the UE in an idle state for a second RAT. The operations of 1505 may be performed according to the methods described herein. In certain examples, aspects of the operations of 1505 may be performed by a receiver as described with reference to FIGS. 7 through 9.

At 1510 the UE 115 may receive the device-to-device communication from the base station of the second wireless network, the device-to-device communication including location information for a base station of a second wireless network, the device-to-device communication formatted as a UE transmission. The operations of 1510 may be performed according to the methods described herein. In certain examples, aspects of the operations of 1510 may be performed by a receiver as described with reference to FIGS. 7 through 9.

At 1515 the UE 115 may activate radio components of the UE into an active state based at least in part on the location information for the base station of the second wireless network, the radio components configured to support communications using the second RAT. The operations of 1515 may be performed according to the methods described herein. In certain examples, aspects of the operations of 1515 may be performed by a UE power management controller as described with reference to FIGS. 7 through 9.

At 1520 the UE 115 may initiate a cell search procedure for the second RAT using the activated radio components. The operations of 1520 may be performed according to the methods described herein. In certain examples, aspects of the operations of 1520 may be performed by a cell search manager as described with reference to FIGS. 7 through 9.

In some cases, receiving the device-to-device communication may include receiving the device-to-device communication from the base station of the second wireless network, the device-to-device communication formatted as a UE transmission.

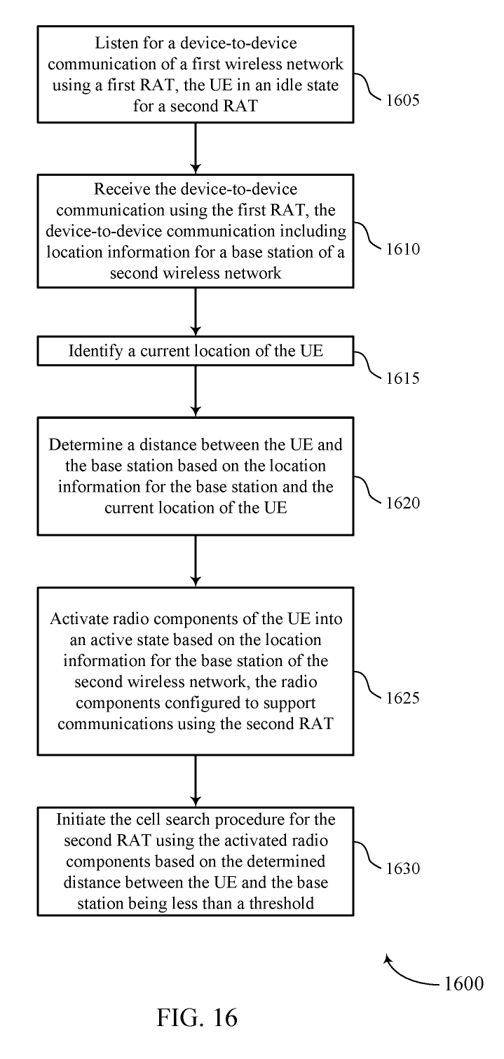

FIG. 16 shows a flowchart illustrating a method 1600 for UE power optimization in mmW access networks in accordance with aspects of the present disclosure. The operations of method 1600 may be implemented by a UE 115 or its components as described herein. For example, the operations of method 1600 may be performed by a UE power management controller as described with reference to FIGS. 7 through 9. In some examples, a UE 115 may execute a set of codes (e.g., firmware code) to control the functional elements of the device to perform the functions described below. Additionally or alternatively, the UE 115 may perform aspects of the functions described below using special-purpose hardware.

At 1605 the UE 115 may listen for a device-to-device communication of a first wireless network using a first RAT, the UE in an idle state for a second RAT. The operations of 1605 may be performed according to the methods described herein. In certain examples, aspects of the operations of 1605 may be performed by a receiver as described with reference to FIGS. 7 through 9.

At 1610 the UE 115 may receive the device-to-device communication using the first RAT, the device-to-device communication comprising location information for a base station of a second wireless network. The operations of 1610 may be performed according to the methods described herein. In certain examples, aspects of the operations of 1610 may be performed by a receiver as described with reference to FIGS. 7 through 9.

At 1615 the UE 115 may identify a current location of the UE. The operations of 1615 may be performed according to the methods described herein. In certain examples, aspects of the operations of 1615 may be performed by a location manager as described with reference to FIGS. 7 through 9.

At 1620 the UE 115 may determine a distance between the UE and the base station based at least in part on the location information for the base station and the current location of the UE. The operations of 1620 may be performed according to the methods described herein. In certain examples, aspects of the operations of 1620 may be performed by a location manager as described with reference to FIGS. 7 through 9.

At 1625 the UE 115 may activate radio components of the UE into an active state based at least in part on the location information for the base station of the second wireless network, the radio components configured to support communications using the second RAT. The operations of 1625 may be performed according to the methods described herein. In certain examples, aspects of the operations of 1625 may be performed by a UE power management controller as described with reference to FIGS. 7 through 9.

At 1630 the UE 115 may initiate the cell search procedure for the second RAT using the activated radio components based at least in part on the determined distance between the UE and the base station being less than a threshold. The operations of 1630 may be performed according to the methods described herein. In certain examples, aspects of the operations of 1630 may be performed by a cell search manager as described with reference to FIGS. 7 through 9.

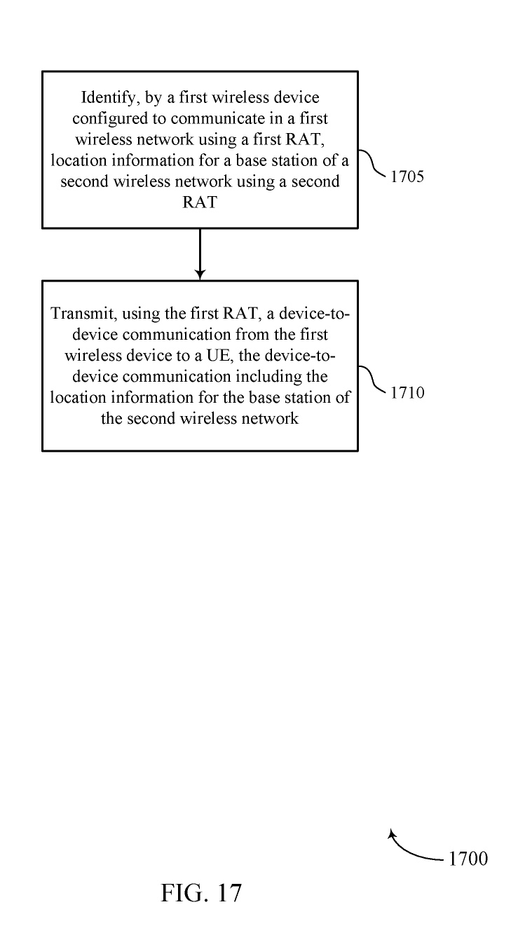

FIG. 17 shows a flowchart illustrating a method 1700 for UE power optimization in mmW access networks in accordance with aspects of the present disclosure. The operations of method 1700 may be implemented by a wireless device 205 or its components as described herein. For example, the operations of method 1700 may be performed by a wireless device manager as described with reference to FIGS. 10 through 12. In some examples, a wireless device 205 may execute a set of firmware code (e.g., firmware code) to control the functional elements of the device to perform the functions described below. Additionally or alternatively, the wireless device 205 may perform aspects of the functions described below using special-purpose hardware.

At 1705 the wireless device 205 may identify, by a first wireless device configured to communicate in a first wireless network using a first RAT, location information for a base station of a second wireless network using a second RAT. The operations of 1705 may be performed according to the methods described herein. In certain examples, aspects of the operations of 1705 may be performed by a location identifier as described with reference to FIGS. 10 through 12.

At 1710 the wireless device 205 may transmit, using the first RAT, a device-to-device communication from the first wireless device to a UE, the device-to-device communication comprising the location information for the base station of the second wireless network. The operations of 1710 may be performed according to the methods described herein. In certain examples, aspects of the operations of 1710 may be performed by a transmitter as described with reference to FIGS. 10 through 12.

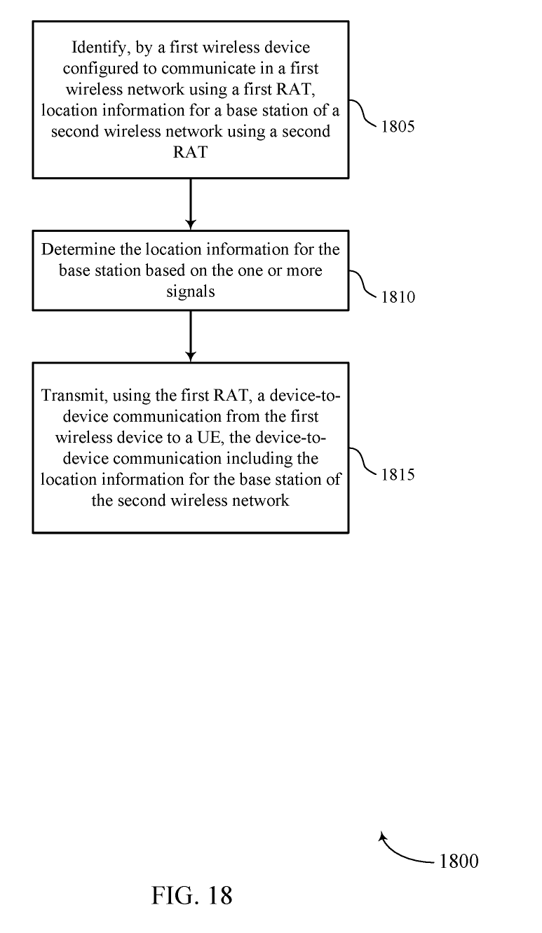

FIG. 18 shows a flowchart illustrating a method 1800 for UE power optimization in mmW access networks in accordance with aspects of the present disclosure. The operations of method 1800 may be implemented by a wireless device 205 or its components as described herein. For example, the operations of method 1800 may be performed by a wireless device manager as described with reference to FIGS. 10 through 12. In some examples, a wireless device 205 may execute a set of codes to control the functional elements of the device to perform the functions described below. Additionally or alternatively, the wireless device 205 may perform aspects of the functions described below using special-purpose hardware.

At 1805 the wireless device 205 may identify, by a first wireless device configured to communicate in a first wireless network using a RAT, location information for a base station of a second wireless network using a second RAT. The operations of 1805 may be performed according to the methods described herein. In certain examples, aspects of the operations of 1805 may be performed by a location identifier as described with reference to FIGS. 10 through 12.

At 1810 the wireless device 205 may determine the location information for the base station based at least in part on the one or more signals. The operations of 1810 may be performed according to the methods described herein. In certain examples, aspects of the operations of 1810 may be performed by a location identifier as described with reference to FIGS. 10 through 12.

At 1815 the wireless device 205 may transmit, using the first RAT, a device-to-device communication from the first wireless device to a UE, the device-to-device communication comprising the location information for the base station of the second wireless network. The operations of 1815 may be performed according to the methods described herein. In certain examples, aspects of the operations of 1815 may be performed by a transmitter as described with reference to FIGS. 10 through 12.

In some cases, identifying the location information for the second wireless network may include receiving, at the first wireless device, one or more signals from the base station of the second wireless network using the first RAT, signals from UEs that may have moved beyond the second RAT coverage area and other active connected state UEs that support device to device communications.

It should be noted that the methods described above describe possible implementations, and that the operations and the steps may be rearranged or otherwise modified and that other implementations are possible. Further, aspects from two or more of the methods may be combined.

Techniques described herein may be used for various wireless communications systems such as code division multiple access (CDMA), time division multiple access (TDMA), frequency division multiple access (FDMA), orthogonal frequency division multiple access (OFDMA), single carrier frequency division multiple access (SC-FDMA), and other systems. A CDMA system may implement a radio technology such as CDMA2000, Universal Terrestrial Radio Access (UTRA), etc. CDMA2000 covers IS-2000, IS-95, and IS-856 standards. IS-2000 Releases may be commonly referred to as CDMA2000 1×, 1×, etc. IS-856 (TIA-856) is commonly referred to as CDMA2000 1xEV-DO, High Rate Packet Data (HRPD), etc. UTRA includes Wideband CDMA (WCDMA) and other variants of CDMA. A TDMA system may implement a radio technology such as Global System for Mobile Communications (GSM).

An OFDMA system may implement a radio technology such as Ultra Mobile Broadband (UMB), Evolved UTRA (E-UTRA), Institute of Electrical and Electronics Engineers (IEEE) 802.11 (Wi-Fi), IEEE 802.16 (WiMAX), IEEE 802.20, Flash-OFDM, etc. UTRA and E-UTRA are part of Universal Mobile Telecommunications System (UMTS). LTE, LTE-A, and LTE-A Pro are releases of UMTS that use E-UTRA. UTRA, E-UTRA, UMTS, LTE, LTE-A, LTE-A Pro, NR, and GSM are described in documents from the organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned above as well as other systems and radio technologies. While aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR applications.

A macro cell generally covers a relatively large geographic area (e.g., several kilometers in radius) and may allow unrestricted access by UEs 115 with service subscriptions with the network provider. A small cell may be associated with a lower-powered base station 105, as compared with a macro cell, and a small cell may operate in the same or different (e.g., licensed, unlicensed, etc.) frequency bands as macro cells. Small cells may include pico cells, femto cells, and micro cells according to various examples. A pico cell, for example, may cover a small geographic area and may allow unrestricted access by UEs 115 with service subscriptions with the network provider. A femto cell may also cover a small geographic area (e.g., a home) and may provide restricted access by UEs 115 having an association with the femto cell (e.g., UEs 115 in a closed subscriber group (CSG), UEs 115 for users in the home, and the like). An eNB for a macro cell may be referred to as a macro eNB. An eNB for a small cell may be referred to as a small cell eNB, a pico eNB, a femto eNB, or a home eNB. An eNB may support one or multiple (e.g., two, three, four, and the like) cells, and may also support communications using one or multiple component carriers.

The wireless communications system 100 or systems described herein may support synchronous or asynchronous operation. For synchronous operation, the base stations 105 may have similar frame timing, and transmissions from different base stations 105 may be approximately aligned in time. For asynchronous operation, the base stations 105 may have different frame timing, and transmissions from different base stations 105 may not be aligned in time. The techniques described herein may be used for synchronous operations.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a digital signal processor (DSP), an application-specific integrated circuit (ASIC), a field-programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media may comprise random-access memory (RAM), read-only memory (ROM), electrically erasable programmable read only memory (EEPROM), flash memory, compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for wireless communication at a user equipment (UE), comprising:
listening for a device-to-device communication of a first wireless network using a first radio access technology (RAT), the UE in an idle state for a second RAT;
receiving the device-to-device communication using the first RAT, the device-to-device communication comprising location information for a base station of a second wireless network;
activating radio components of the UE into an active state based at least in part on the location information for the base station of the second wireless network, the radio components configured to support communications using the second RAT; and
initiating a cell search procedure for the second RAT using the activated radio components.

2. The method of claim 1, wherein receiving the device-to-device communication comprises:
receiving the device-to-device communication from a second UE using the first RAT, the location information for the base station of the second wireless network based at least in part on signals received at the second UE in a connected state with the base station of the second wireless network.

3. The method of claim 1, wherein receiving the device-to-device communication comprises:
receiving the device-to-device communication from the base station of the second wireless network, the device-to-device communication formatted as a first RAT UE transmission.

4. The method of claim 1, further comprising:
initiating a cell search procedure based at least in part on a determined distance between the UE and the base station being less than a threshold, or based at least in part on a signal strength being above a threshold, or based at least in part on a quality of coverage measurement at a location of the UE being above a threshold, or a combination thereof.

5. The method of claim 1, further comprising:
receiving one or more additional device-to-device communications from one or more additional UEs, each of the one or more additional device-to-device communications comprising additional location information for the base station of the second wireless network; and
estimating a location of the base station of the second wireless network, or of a coverage area of the base station, or a combination thereof, based at least in part on the one or more additional device-to-device communications.

6. The method of claim 5, wherein the location information comprises coordinates for the UE and an indication of a measurement of a signal received at the UE from the base station.

7. The method of claim 1, further comprising:
receiving, from a plurality of additional UEs, location information for base stations of the second wireless network; and
generating a database of base station locations for the second wireless network and UE locations attached to the second wireless network based at least in part on the received location information.

8. The method of claim 1, wherein listening for the device-to-device communication comprises:
periodically listening for the device-to-device communication during a predetermined time interval for discovery of UEs transmitting device-to-device communications.

9. The method of claim 1, wherein the location information for the second wireless network comprises coordinates for the base station of the second wireless network, or for a coverage area for the base station, or a combination thereof.

10. The method of claim 1, wherein the device-to-device communication further comprises an identifier of the base station of the second wireless network, or a beam identifier for a transmit beam of the base station, or a measurement of a reference signal transmitted by the base station, or a combination thereof.

11. The method of claim 1, wherein:
the first RAT operates using a radio frequency (RF) spectrum band less than 6 GHz; and
the second RAT operates using a RF spectrum band greater than 6 GHz.

12. The method of claim 1, wherein listening for the device-to-device communication using the first RAT further comprises:
listening for the device-to-device communication in an idle state for the first RAT.

13. The method of claim 1, wherein listening for the device-to-device communication using the first RAT further comprises:
listening for the device-to-device communication in an active state for the first RAT.

14. The method of claim 1, wherein the first wireless network and the second wireless network geographically overlap.

15. A method for wireless communication, comprising:
identifying, by a first wireless device configured to communicate in a first wireless network using a first radio access technology (RAT), location information for a base station of a second wireless network using a second RAT; and
transmitting, using the first RAT, a device-to-device communication from the first wireless device to a user equipment (UE), the device-to-device communication comprising the location information for the base station of the second wireless network.

16. The method of claim 15, wherein identifying the location information for the second wireless network comprises:
receiving, at the first wireless device, one or more signals from the base station of the second wireless network using the second RAT; and
determining the location information for the base station based at least in part on the one or more signals.

17. The method of claim 16, wherein the one or more signals from the base station comprise a system information signal of the base station, or a reference signal transmitted by the base station, or a combination thereof.

18. The method of claim 15, wherein the base station of the second wireless network comprises the first wireless device, and the base station is enabled or configured to transmit the device-to-device communication as a UE transmission.

19. The method of claim 18, wherein the first wireless device comprises a UE embedded in the base station to transmit the device-to-device communication configured as the UE transmission.

20. The method of claim 15, further comprising:
measuring a signal transmitted by the base station of the second wireless network, wherein the location information comprises coordinates for the first wireless device and an indication of the measured signal.

21. The method of claim 15, wherein the location information comprises coordinates for the base station of the second wireless network, or for a coverage area of the base station, or a combination thereof

22. An apparatus for wireless communication, comprising:
a processor;
memory in electronic communication with the processor; and
instructions stored in the memory and executable by the processor to cause the apparatus to:
listen for a device-to-device communication of a first wireless network using a first radio access technology (RAT), the apparatus in an idle state for a second RAT;
receive the device-to-device communication using the first RAT, the device-to-device communication comprising location information for a base station of a second wireless network;
activate radio components of the apparatus into an active state based at least in part on the location information for the base station of the second wireless network, the radio components configured to support communications using the second RAT; and
initiate a cell search procedure using the activated radio components.

23. The apparatus of claim 22, wherein the instructions to receive the device-to-device communication are executable by the processor to cause the apparatus to:
receive the device-to-device communication from a second apparatus using the first RAT, the location information for the base station based at least in part on signals received at the second apparatus from the base station of the second wireless network.

24. The apparatus of claim 22, wherein the instructions to receive the device-to-device communication are executable by the processor to cause the apparatus to:
receive the device-to-device communication from the base station of the second wireless network, the device-to-device communication formatted as an apparatus transmission.

25. The apparatus of claim 22, wherein the instructions are further executable by the processor to cause the apparatus to:
identify a current location of the apparatus;
determine a distance between the apparatus and the base station based at least in part on the location information for the base station and the current location of the apparatus; and
initiate the cell search procedure based at least in part on the determined distance between the apparatus and the base station being less than a threshold.

26. The apparatus of claim 22, wherein the instructions are further executable by the processor to cause the apparatus to:
receive one or more additional device-to-device communications from one or more additional apparatuses, each of the one or more additional device-to-device communications comprising additional location information for the base station of the second wireless network; and
estimate a location of the base station of the second wireless network, or of a coverage area of the base station, or a combination thereof, based at least in part on the one or more additional device-to-device communications.

27. The apparatus of claim 26, wherein the location information comprises coordinates for the apparatus and an indication of a measurement of a signal received at the apparatus from the base station.

28. An apparatus for wireless communication, comprising:
a processor;
memory in electronic communication with the processor; and
instructions stored in the memory and executable by the processor to cause the apparatus to:
identify, by a first wireless device configured to communicate in a first wireless network using a first radio access technology (RAT), location information for a base station of a second wireless network using a second RAT; and
transmit, using the first RAT, a device-to-device communication from the first wireless device to a user equipment (UE), the device-to-device communication comprising the location information for the base station of the second wireless network.

29. The apparatus of claim 28, wherein the instructions to identify the location information for the second wireless network are executable by the processor to cause the apparatus to:
receive, at the first wireless device, one or more signals from the base station of the second wireless network using the first RAT; and
determine the location information for the base station based at least in part on the one or more signals.

30. The apparatus of claim 29, wherein the one or more signals from the base station comprise a system information signal of the base station, or a reference signal transmitted by the base station, or a combination thereof.
